(19) United States
(12) Patent Application Publication
(10) Pub. No.: US 2015/0074075 A1
(43) Pub. Date: Mar. 12, 2015

(54) Symbol Matrix Engine

(71) Applicant: Ryan Alexander, Lynden, WA (US)

(72) Inventor: Ryan Alexander, Lynden, WA (US)

(21) Appl. No.: 14/481,816

(22) Filed: Sep. 9, 2014

Related U.S. Application Data
(60) Provisional application No. 61/875,614, filed on Sep. 9, 2013.
(60) Provisional application No. 61/895,366, filed on Oct. 24, 2013.
(60) Provisional application No. 61/923,144, filed on Jan. 2, 2014.
(60) Provisional application No. 61/923,155, filed on Jan. 2, 2014.
(60) Provisional application No. 61/942,999, filed on Feb. 21, 2014.

(51) Int. Cl. G06F 17/30

(52) U.S. Cl. CPC G06F 17/30864
USPC 707/706

(57) ABSTRACT

A data visualization system comprising a database, a display system, and a processing system. The database contains a plurality of data fields each containing a plurality of data values. The processing system is in communication with the database system and the display system. The processing system generates display data for at least one displayed data fields of the plurality of data fields. The display data determines visual attributes for each displayed data field based on the data values of the data associated with each displayed data field. The processing system controls the display system to display the display data.

### RELATED APPLICATIONS

This application, U.S. patent application Ser. No. 14/481,816 filed Sep. 9, 2014, claims benefit of U.S. Provisional Application Ser. No. 61/875,614 filed Sep. 9, 2013, currently pending, which is incorporated by reference herein in its entirety.

U.S. patent application Ser. No. 14/481,816, also claims benefit of U.S. Provisional Application Ser. No. 61/895,366 filed Oct. 24, 2013, currently pending, which is incorporated by reference herein in its entirety.

U.S. patent application Ser. No. 14/481,816, also claims benefit of U.S. Provisional Application Ser. No. 61/923,144 filed Jan. 2, 2014, currently pending, which is incorporated by reference herein in its entirety.

U.S. patent application Ser. No. 14/481,816, also claims benefit of U.S. Provisional Application Ser. No. 61/923,155 filed Jan. 2, 2014, currently pending, which is incorporated by reference herein in its entirety.

U.S. patent application Ser. No. 14/481,816, also claims benefit of U.S. Provisional Application Serial No. 61/942,999 filed Feb. 21, 2014, currently pending, which is incorporated by reference herein in its entirety.

### TECHNICAL FIELD

SMX-FOs, the visual format & the style-index structured method of visual attribute population entity representative figure object embellishment.

Descriptions & illustrations of inventions core concepts and feature/functionalities.

### BRIEF DESCRIPTION OF THE DRAWINGS

FIG. 1x—SMX-FO showing in stem-tree structure.

FIG. 2x—grid view of active object population.

FIG. 3x-20x—step by step walk through of applying an SMX-FO visual attribute.

FIG. 16x—reserved

FIG. 21x—second reference to underlying entity attribute structure.

FIG. 22x-27x—adding some mock data to demonstrate a standard updating of a value, as opposed to via visual attribute selection with user defined category data. Additionally the method by which the data is accessed to be updated is included as it works with the stem tree structure when viewing element and navigating populations and profiles.

FIG. 28x—the resulting output of the steps illustrated in FIG. 22x—FIG. 27x which demonstrate the structural design of the object attribute focus view in accessing the SMX-FO's attribute values as well as the capability of updating these values. Going step by step; FIG. 22x populates the attribute value elements illustrated in general forma in FIG. 21x with an array of ad hoc hypothetical values; FIG. 23x illustrates the selection of the update operator in the bottom right corner, which populates the update attribute selection operators positioned to the right of the attribute value elements illustrated in FIG. 24x; FIG. 25x illustrates the selection of the update operator associated with the SMX-FO's attribute (B) populating the data control form illustrated in FIG. 26x; FIG. 27x illustrates the input of a new value and selection of the save operator; FIG. 28x shows the SMX-FO once again in the attribute focus view with the updated attribute(B), to the value of one, from its initial value of zero as shown in FIG. 22x.

FIG. 29x—concluding image of standard object attribute related SMX-FO.

FIG. 30x—to support the life data management as process and in order to service a recognized area of need the concept of a user-financed search engine service that will be integrated with the symbol matrix's offered services is referenced.

FIG. 31x—the SMX-FOs are visible from the grid map data table and even integration with calendar and prior art like pie charts and histograms. The map can be transitioned to in which case the SMX-FOs which process the calendar active date related trait are made visible with the timescaling of the maps bounds being automated and the ability to update date related data category of the object will be included. The combination of map grid view and calendar in sync with the SMX-FOs supplies new abilities.

FIG. 32x—symbol matrix “stem tree transitional data navigation portal”. This portal and its format works for navigating profiles, sectors, populations, ultimately it is intended to offer web-resource navigation as well as “SMX-data-domain” navigation through indexing methods and a service agreement that is built on the idea of a SMX-FO integrated search resource included in the service. The figure object control functionalities may be applied to the transformation of sheet music into a variation of the visual format for musicians and those seeking music skills. The use of object control functionality simplify the use of sheet music, which is a difficult figure formats to abstract meanings from.

FIG. 33x—transitioning in the stem tree follows this method where the child element transforms into the parent element or the parent element to that of the child with this same added intuition included—the transitioning of the SMX-FOs is integrate in every aspect—another being the actual selecting of an SMX-FO resulting in a quick fade out of its sibling members and then the SMX-FO then transitions to the “focus position” where navigation options related attributes are connected to the object with the transition design following the same path in reverse transitioning out.

FIG. 33x-41x—navigating the stem tree transitional data structure as well as using the integrated data control features to update such elements as sectors, profiles, sector classes, profile classes, the ability to add-edit-or-create will be available to all the major elements of the stem tree structure which supports the practical use of the SMX-FOs. The ability even to create a population, select/enter the parameters of how many population members, what data categories, the format type of the data categories, is in the blueprint of the stem tree structure for inclusions.

FIG. 34x—reserved

FIG. 42x—sales related profile class “relationship” and its child members of (client, follow up, unsolicited, and eliminated) full control over these elements as well including the association of which visual attributes are associated to the underlying conditions. Profiles and sectors are global to the population to which they are in. A profile class all its child members can be added to the visual format via selecting the profile class stem-tree element whether the element is in the “focus (parent) position” or it is located in the child position—profiles possess a characteristic that sectors don't which is the ability to be both a profile class and profile depending on whether selection of the hybrid profile-profile class element is execute form its position as the focus parent element its children are applied to the visual format. If it is selected from the child position just its instance of conditional-visual attribute parameters will be added to the visual format. The stem tree structure in which this ability to in a very structured and intuitive way control—what exists in their “life data world”—as well as making use of the functionality offered by the SMX-FOs in the visual format.

FIG. 43a—is an example of the same style-index structured visual attribute selection pane but of a different default constitution, small variances like these available enable the ease of differentiating commonly accessed populations for example tasks and sales prospects—although it has been noticed that the hindrance of using the same SMX-FOs in different contexts is minor comparable to using numbers in different contexts. Ultimately the ability to customize the style indexes structure based on population is docketed for integration the list of means and new avenues opened by the breach of the visual format goes on and on . . .

FIG. 44a—is an example of the FIG. 42x profile parameters application to the visual format.

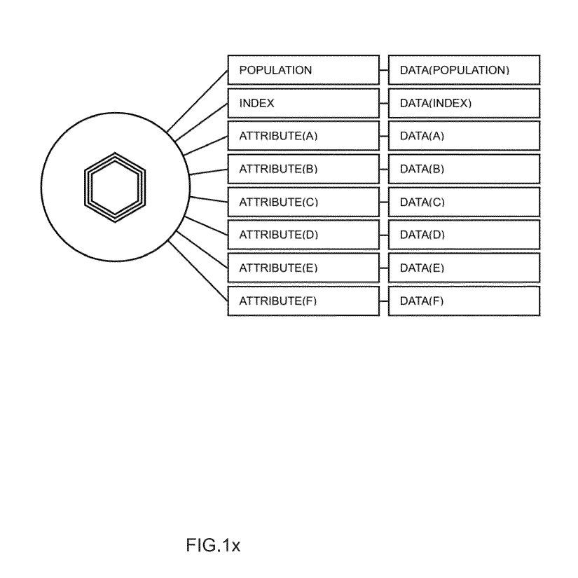

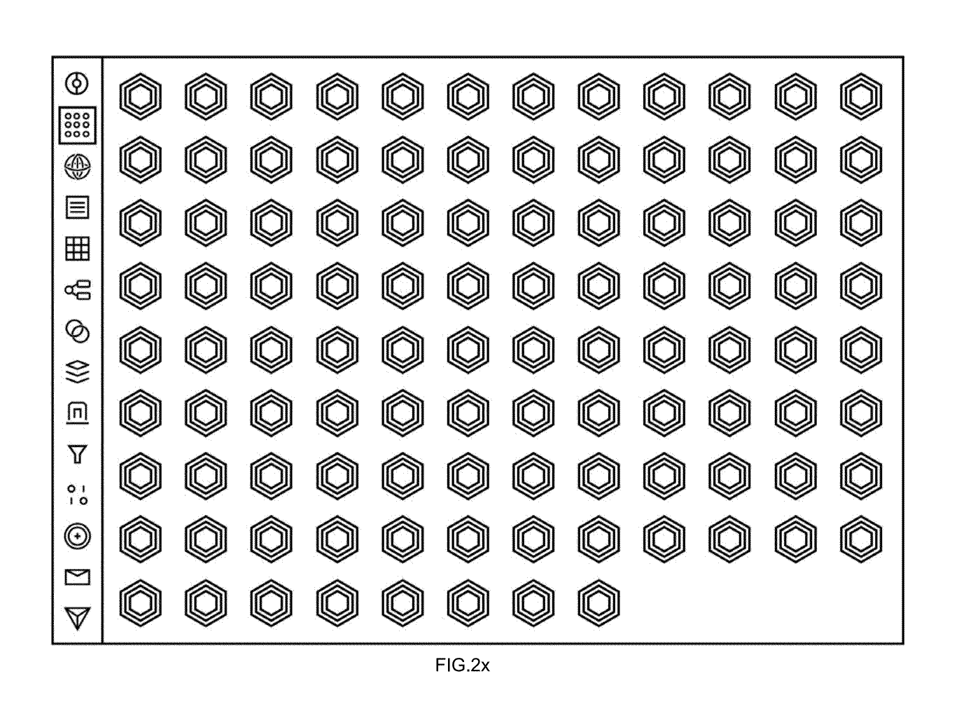

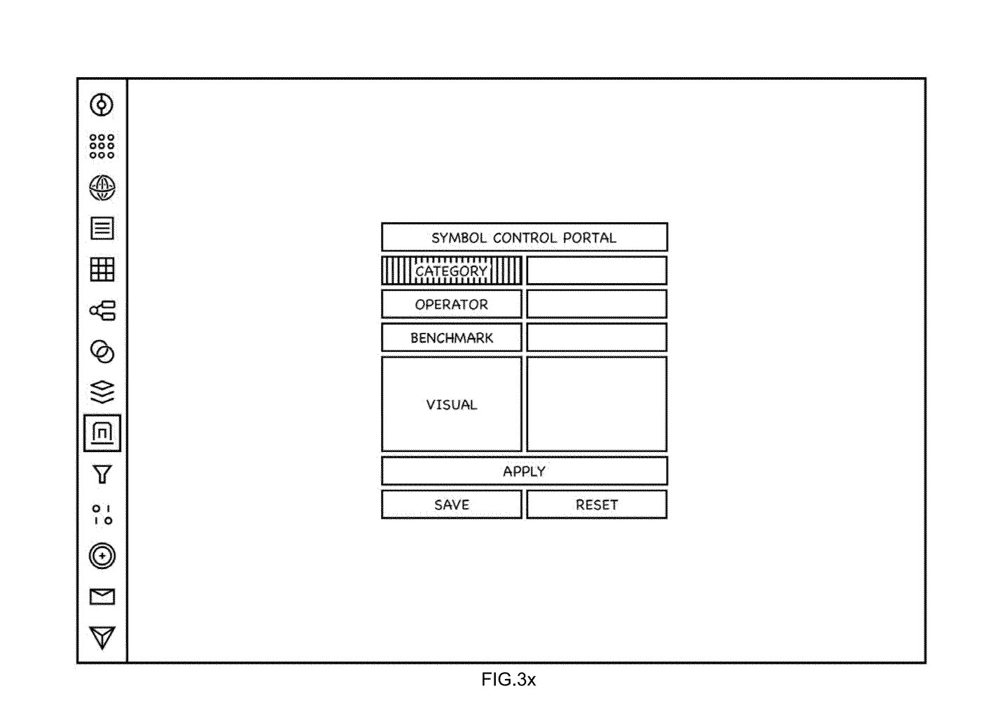

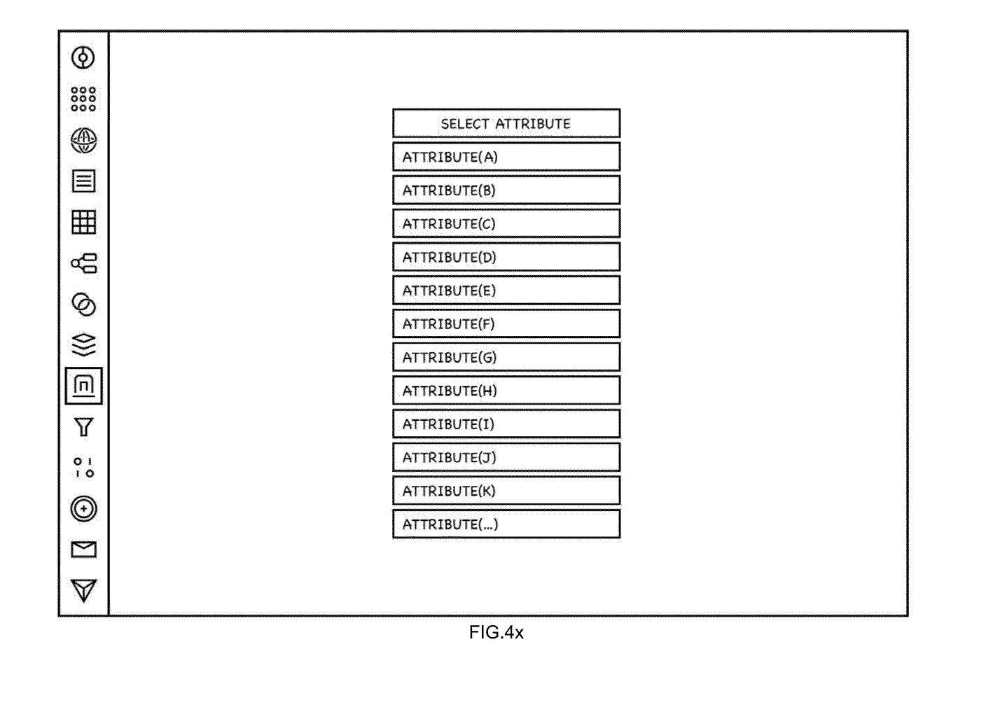

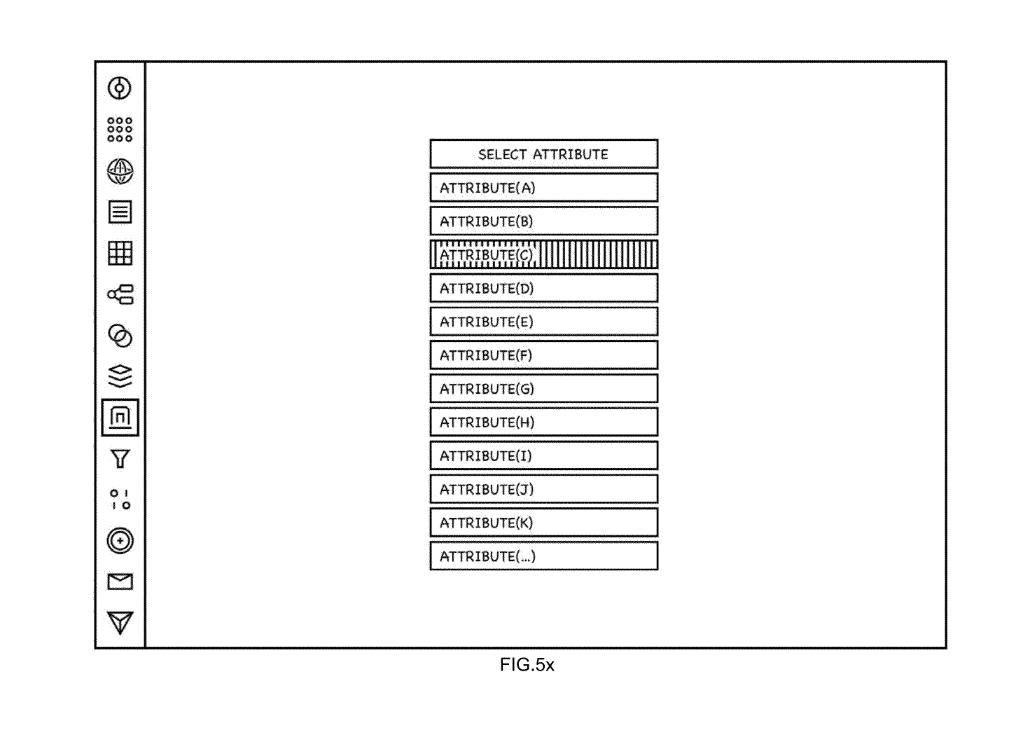

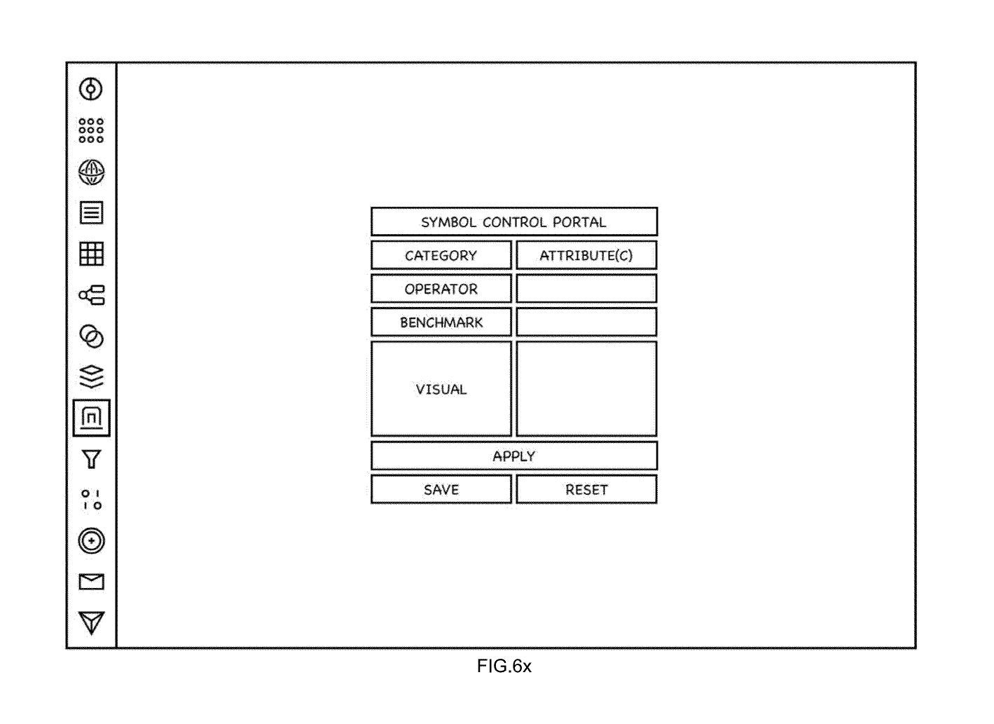

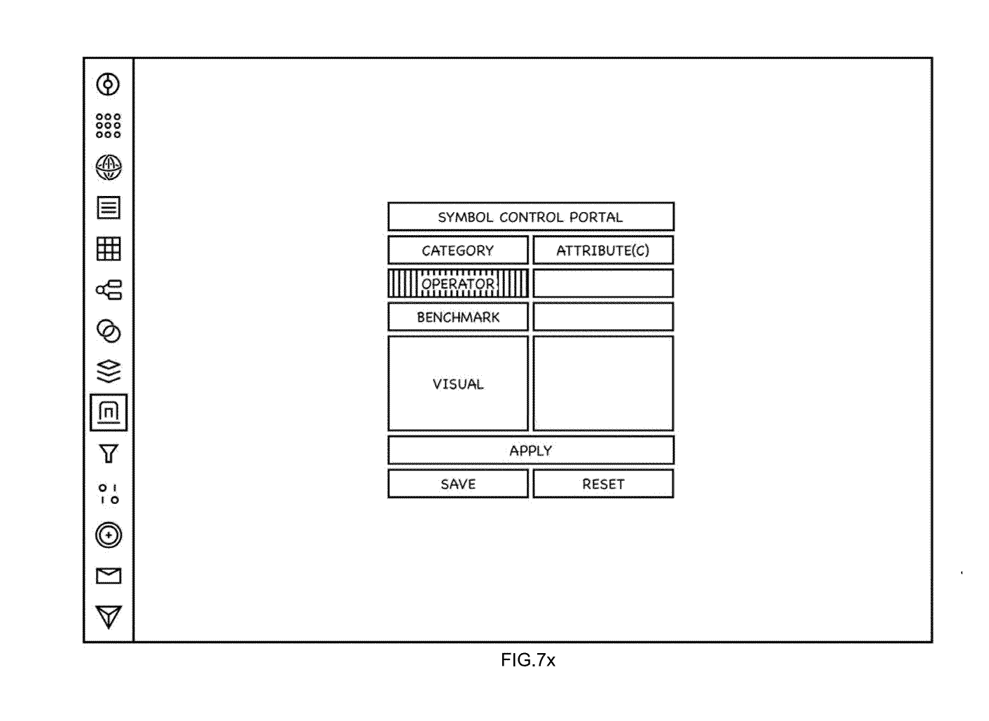

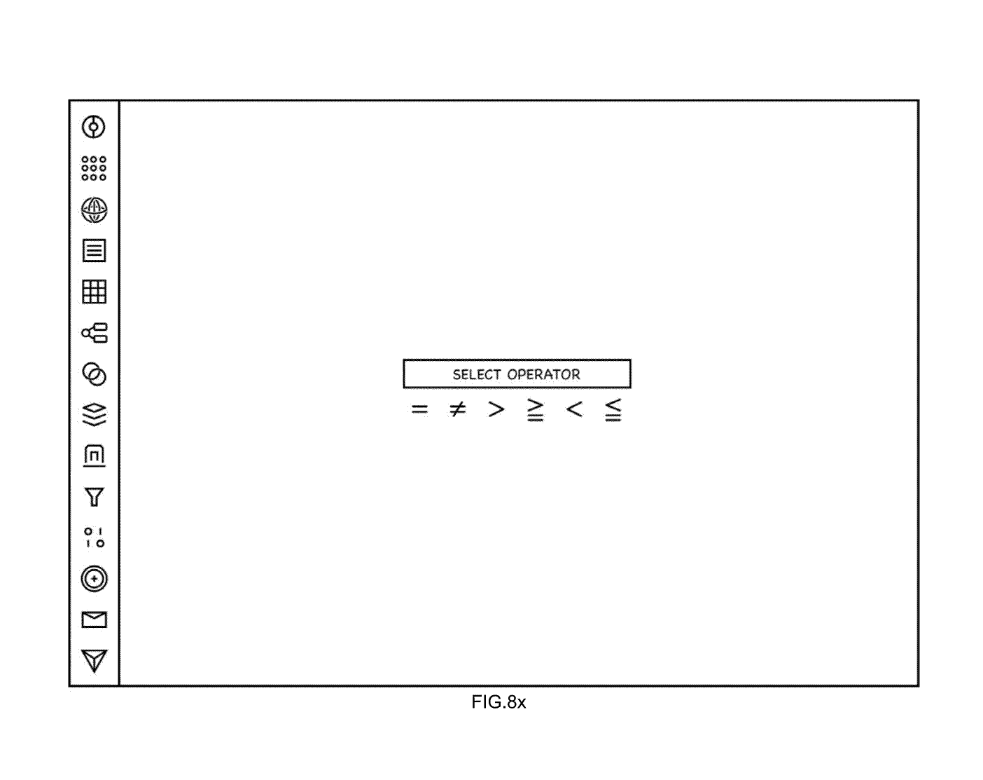

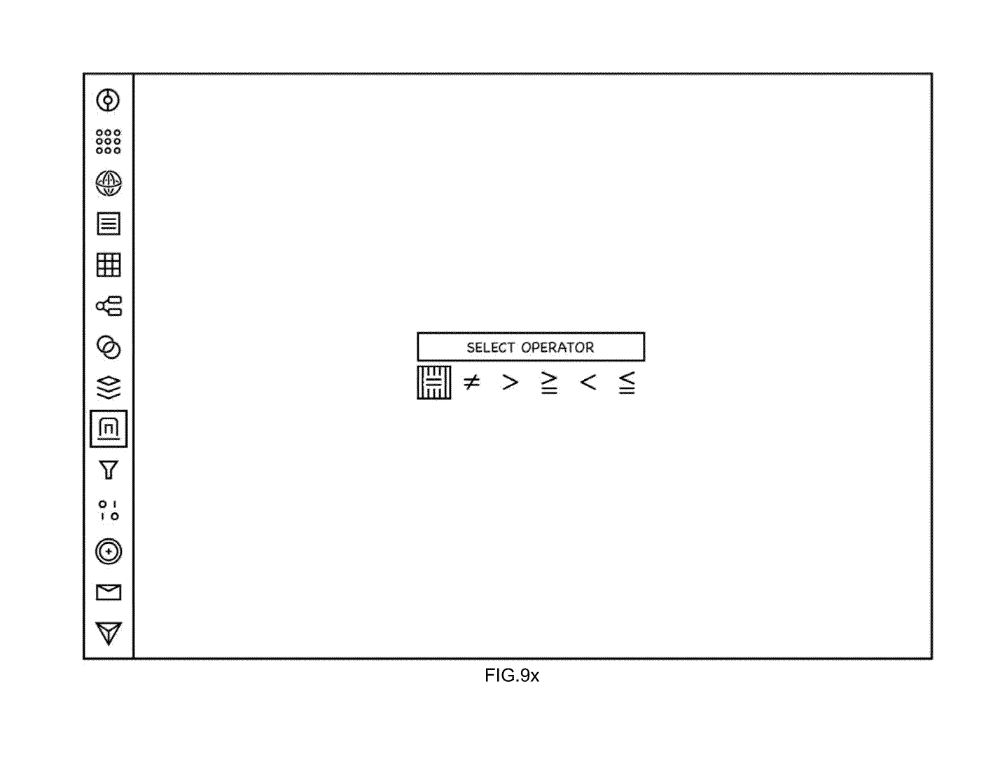

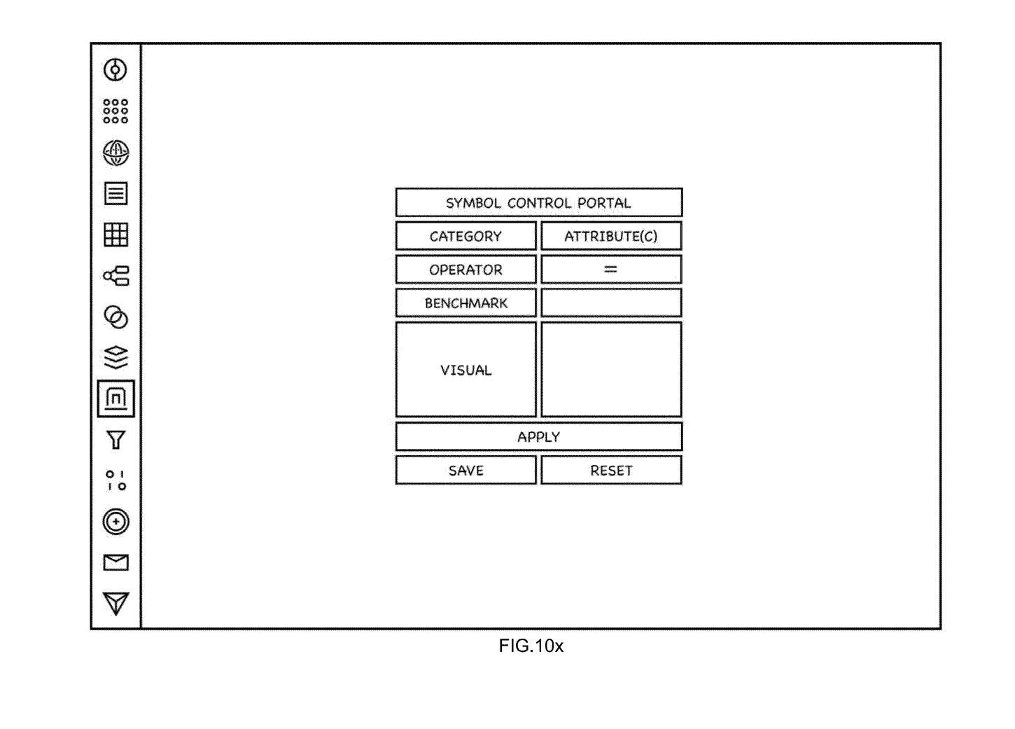

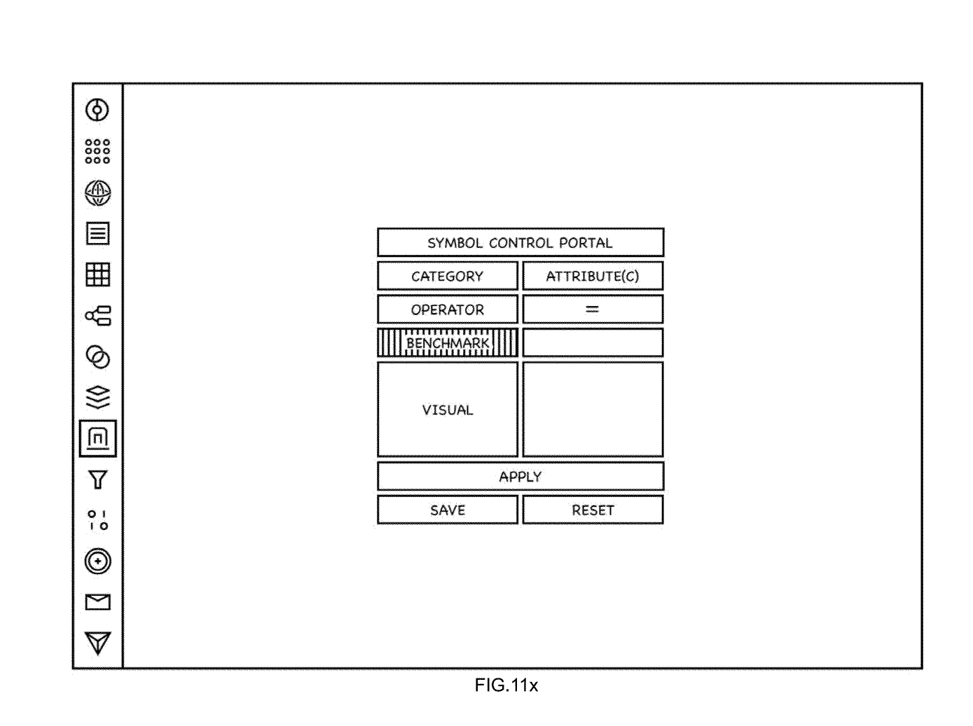

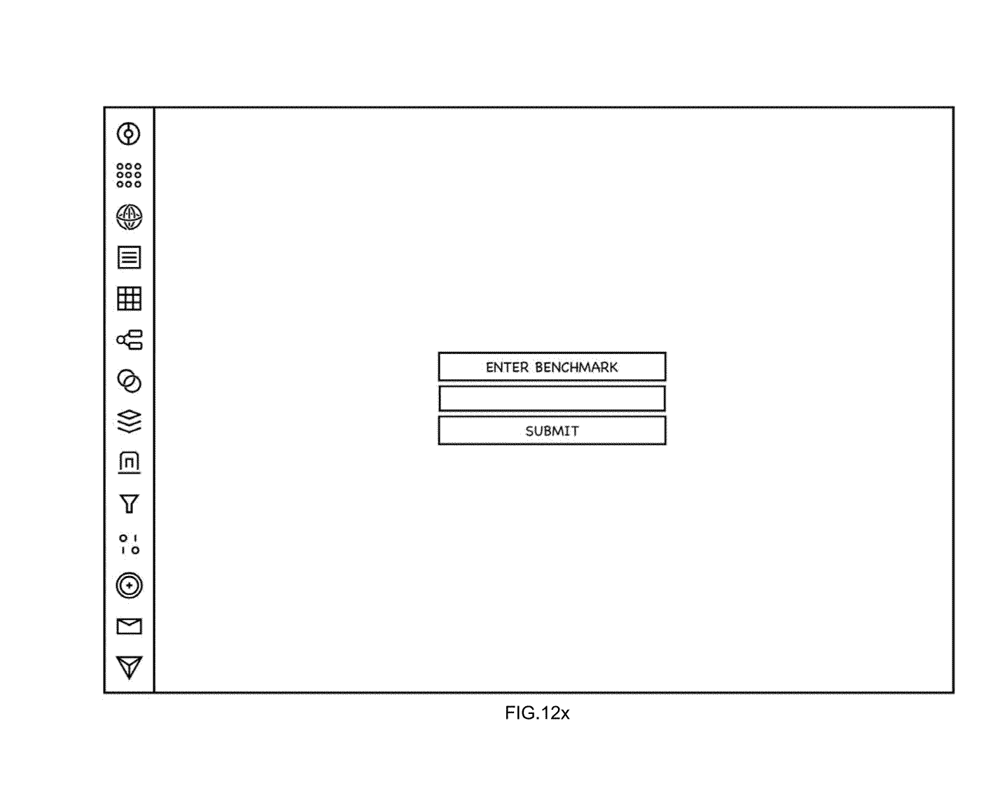

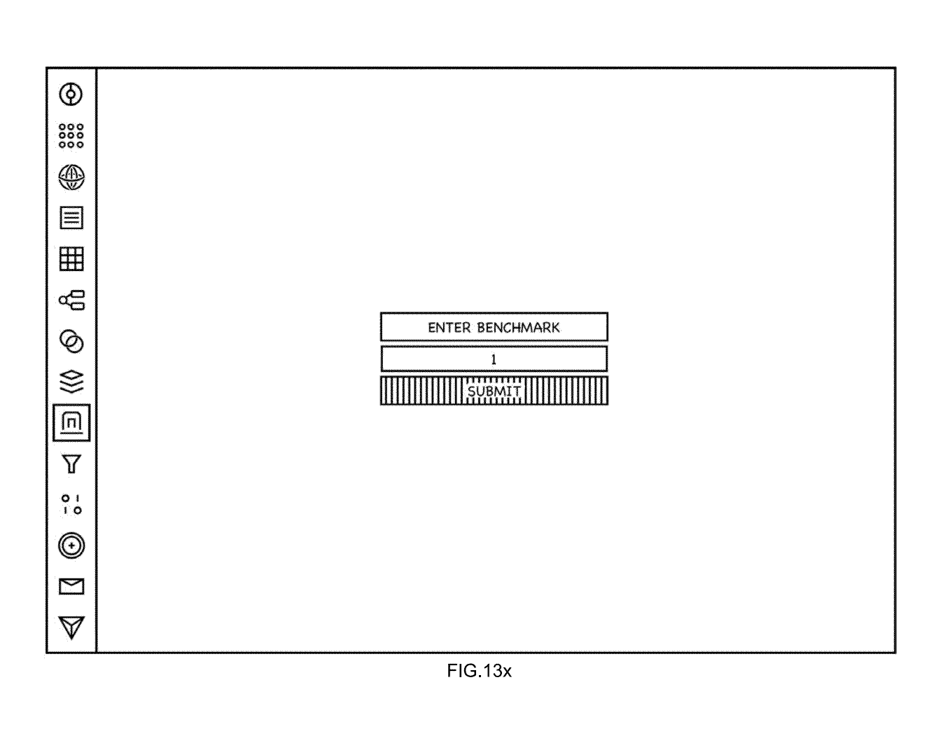

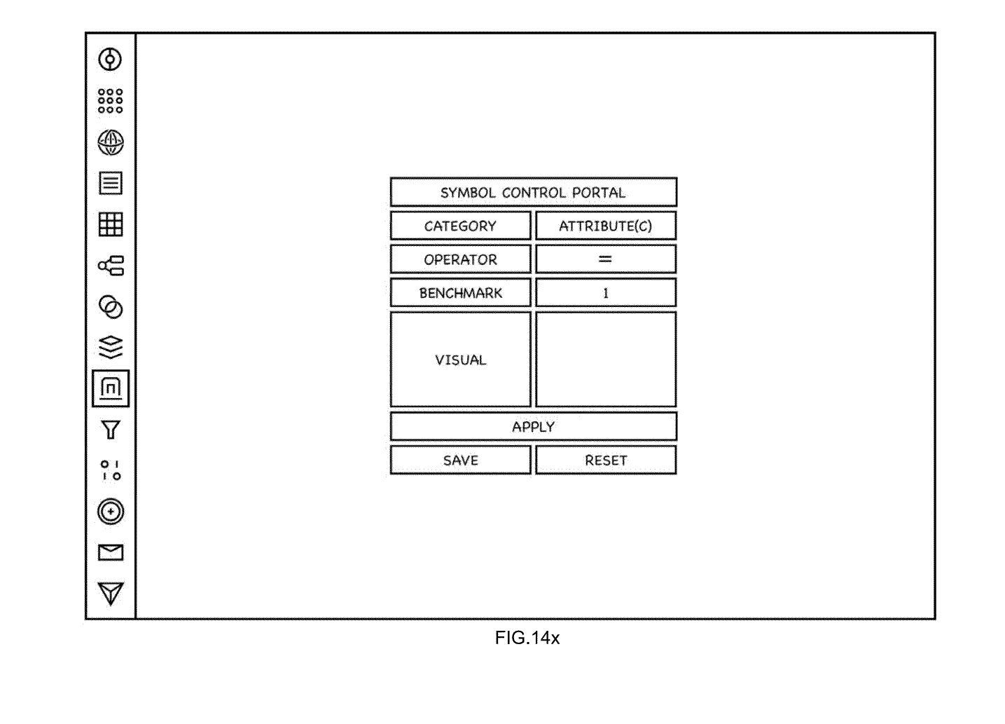

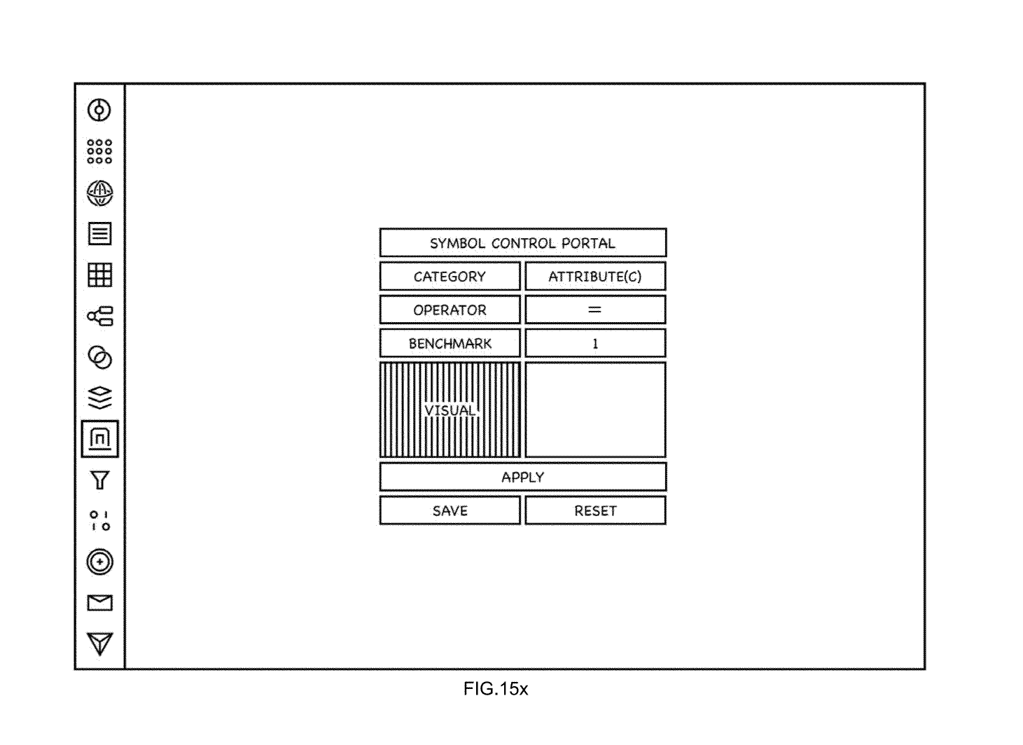

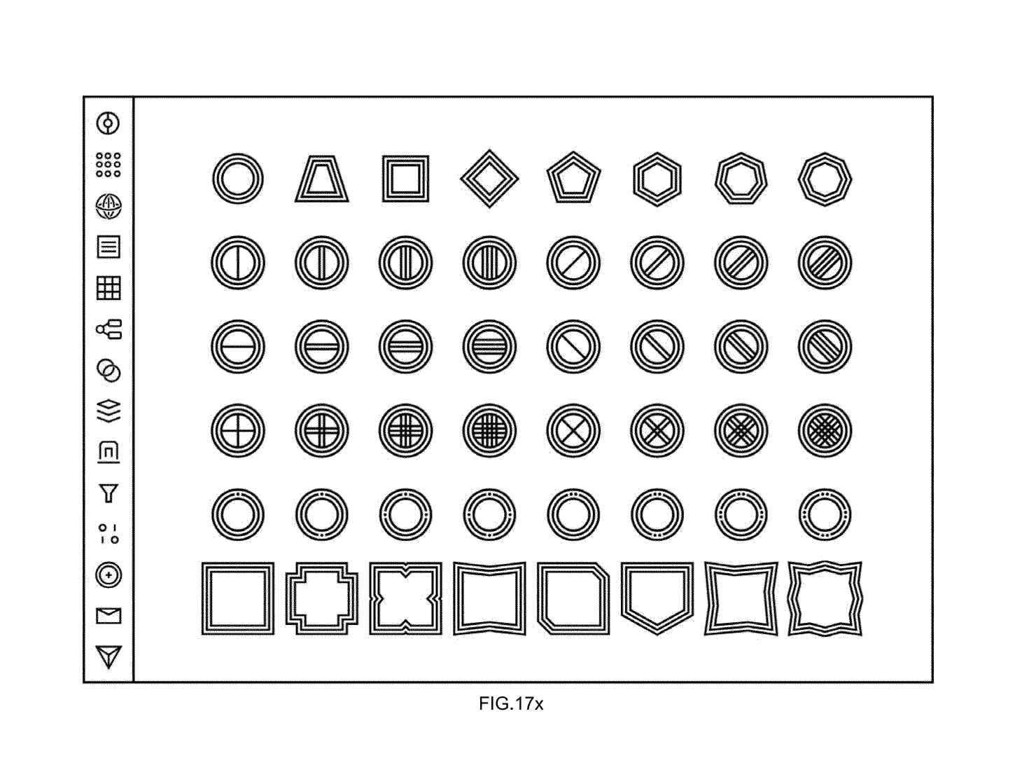

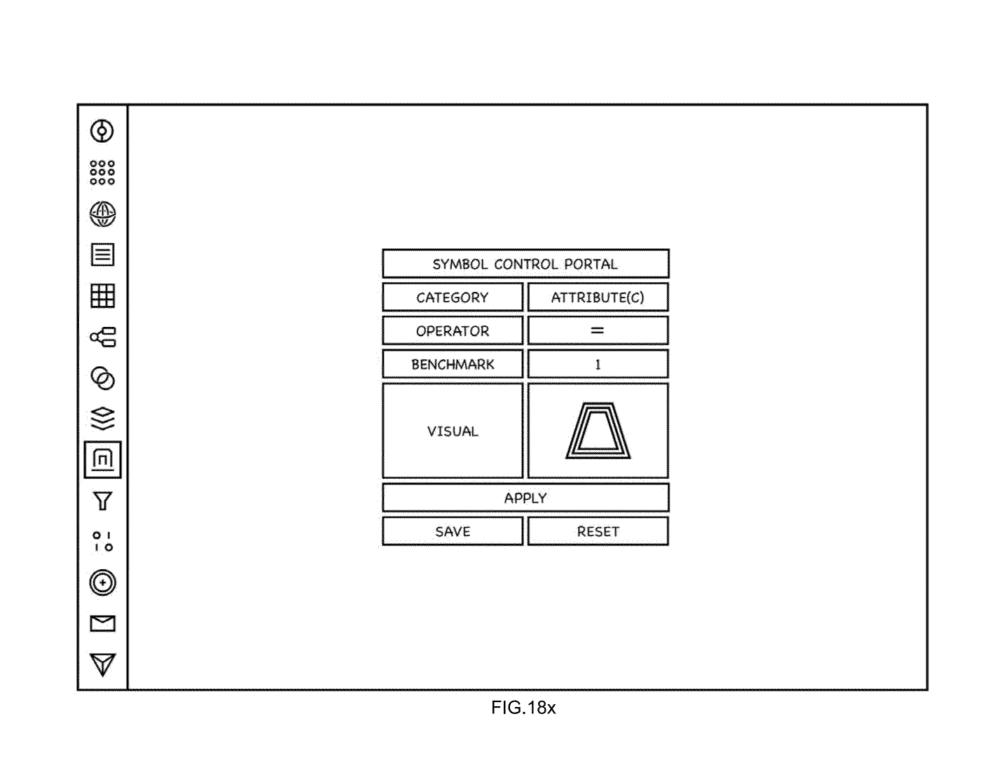

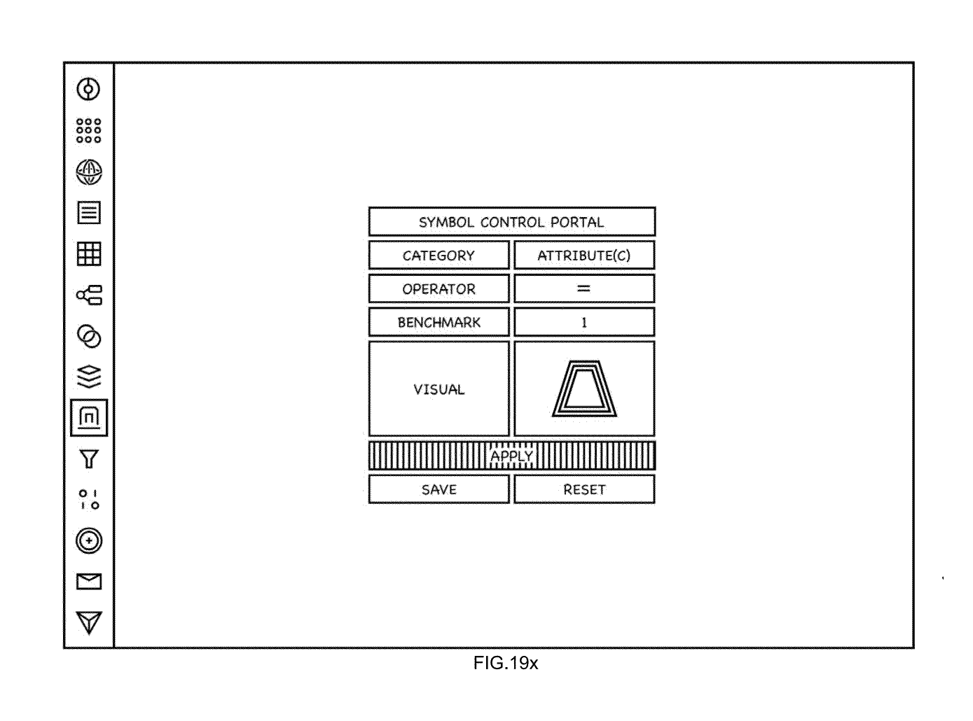

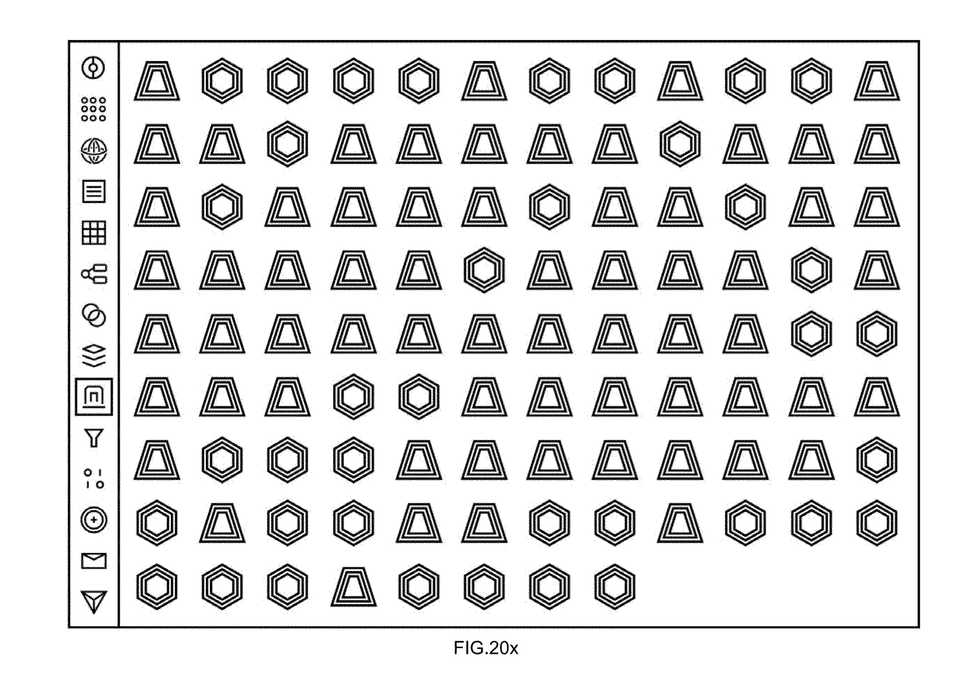

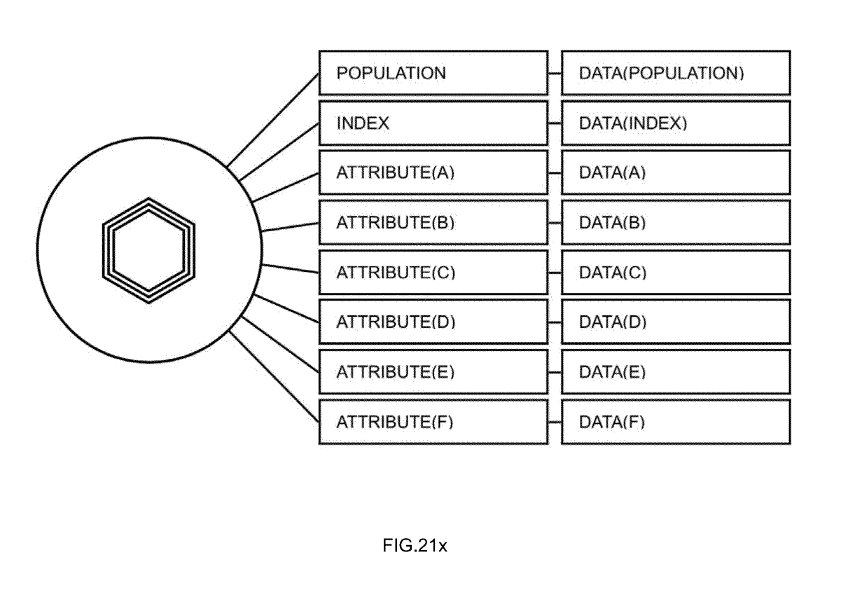

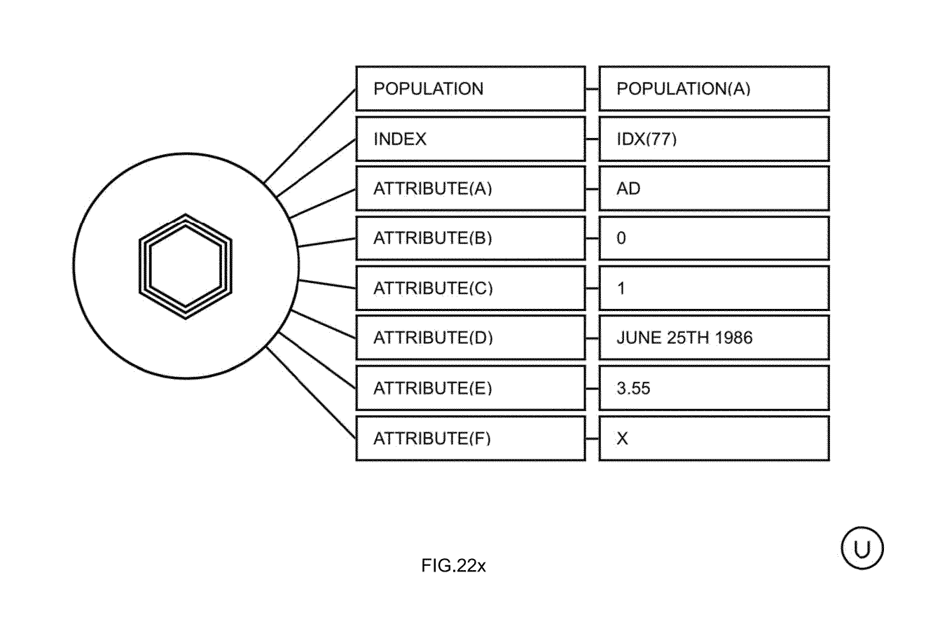

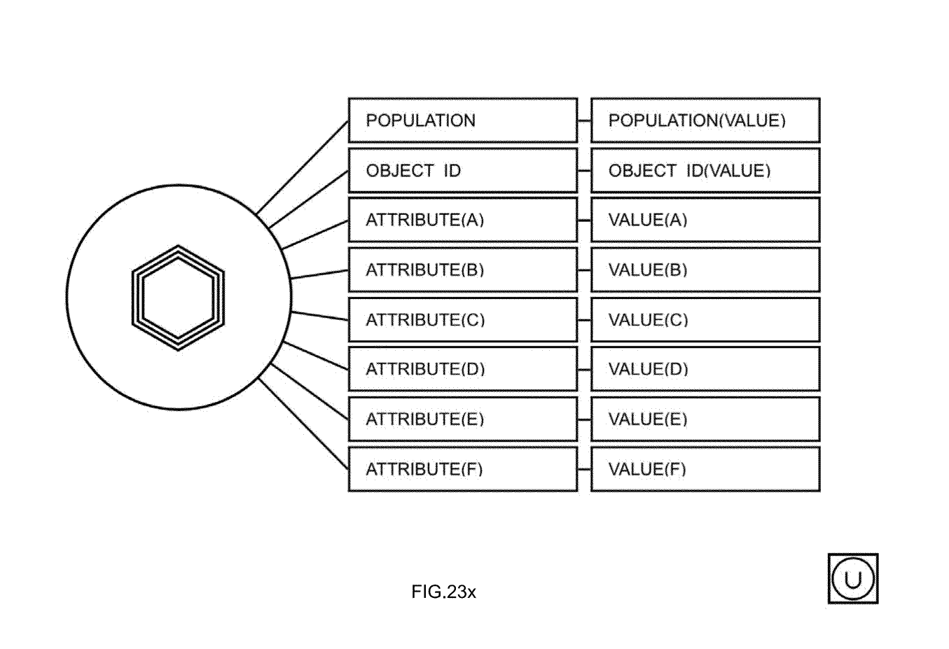

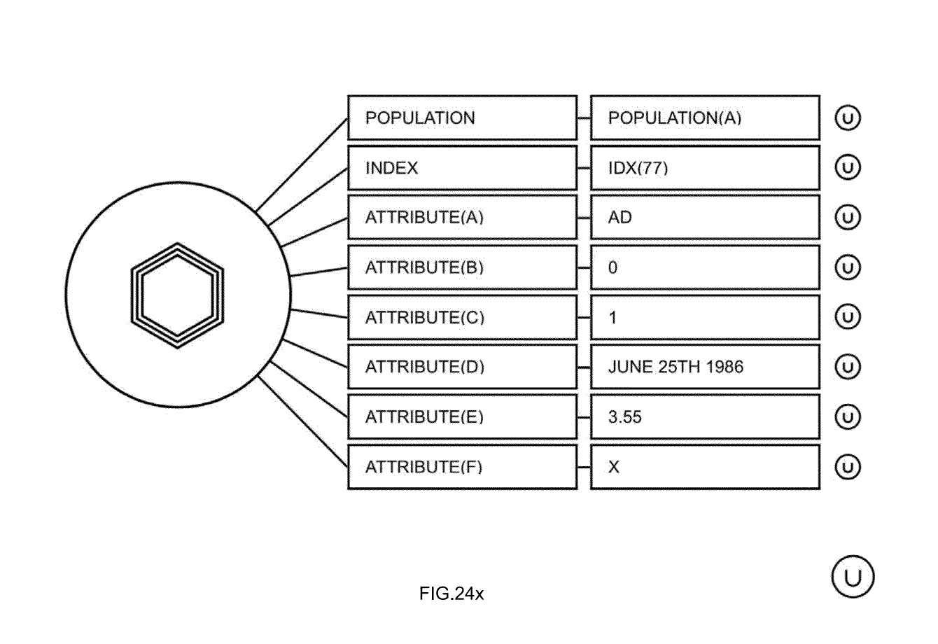

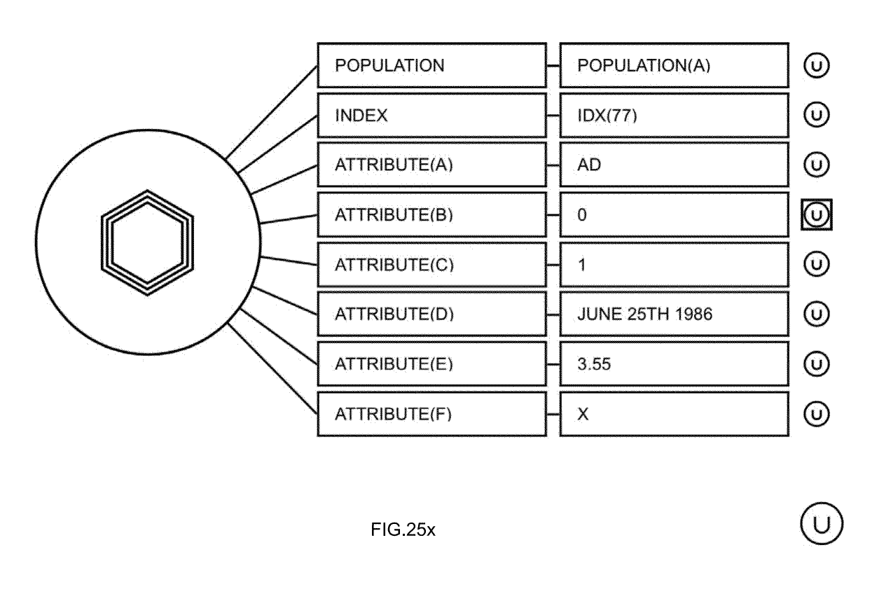

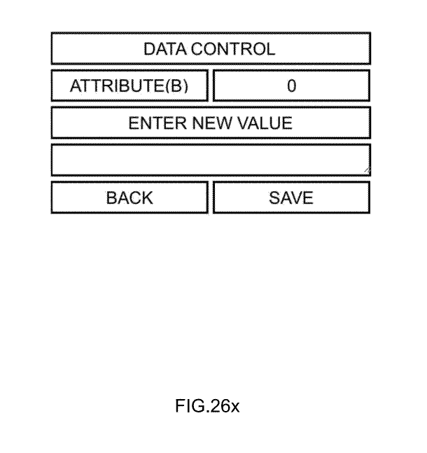

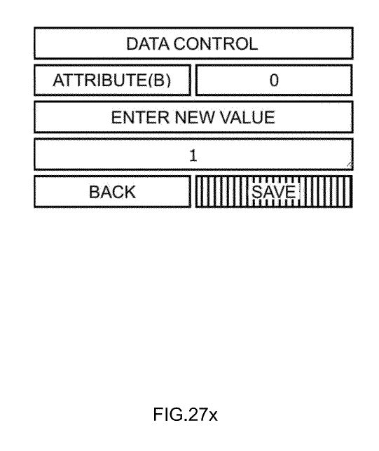

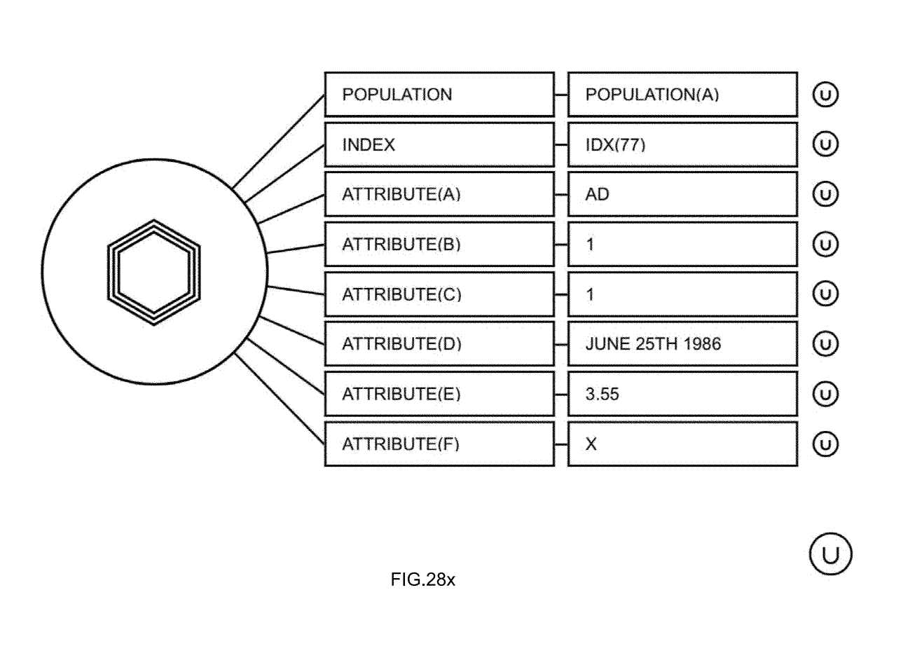

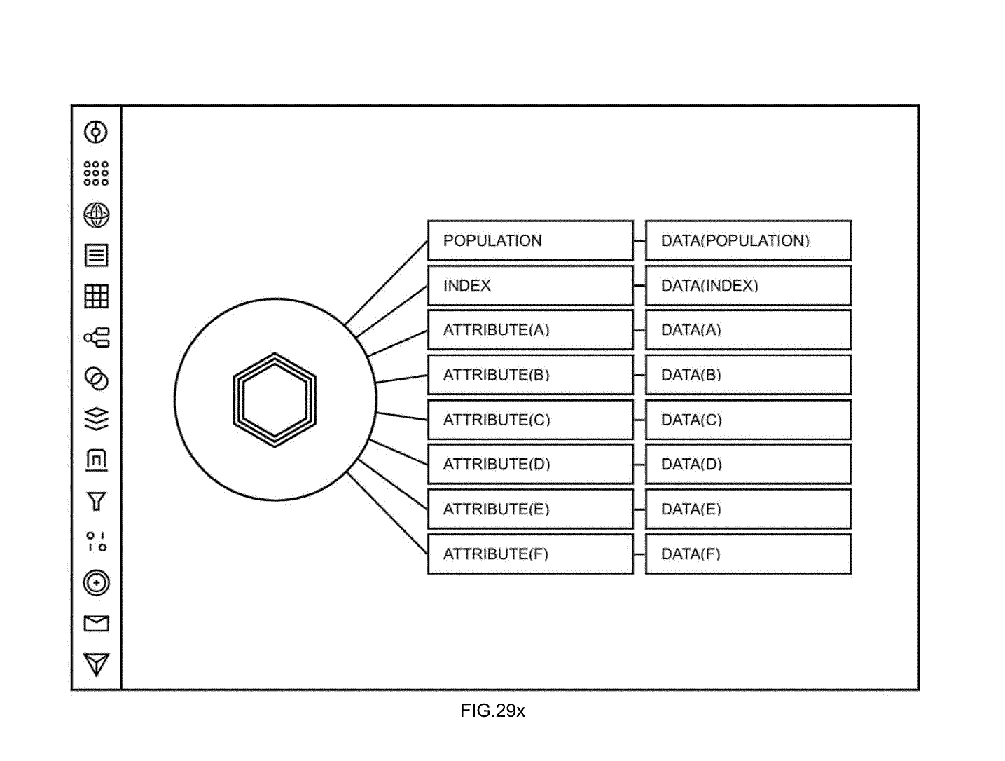

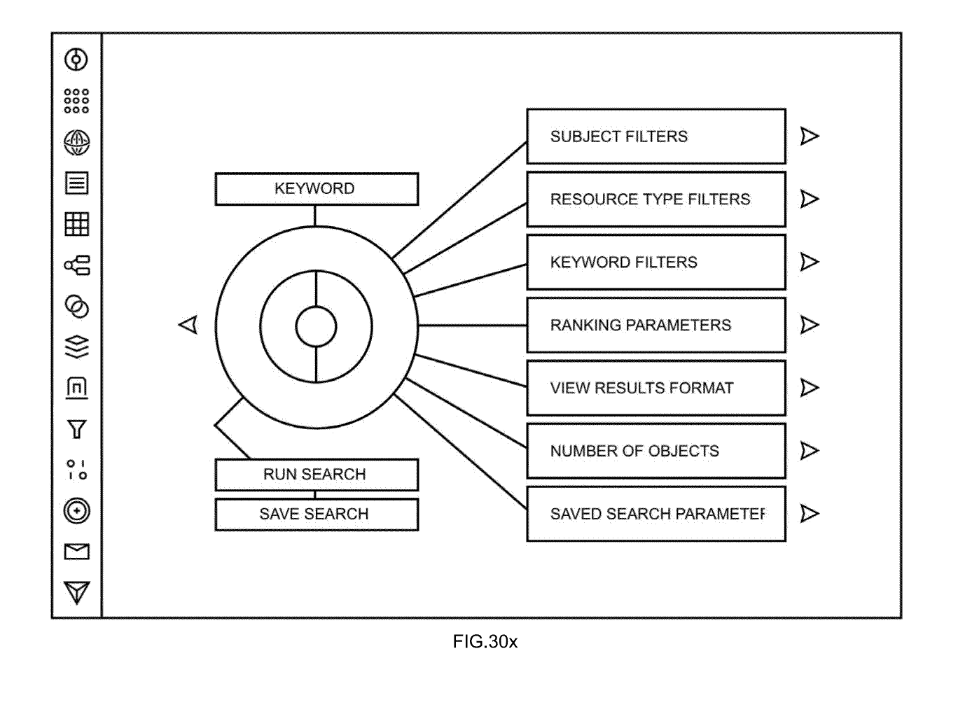

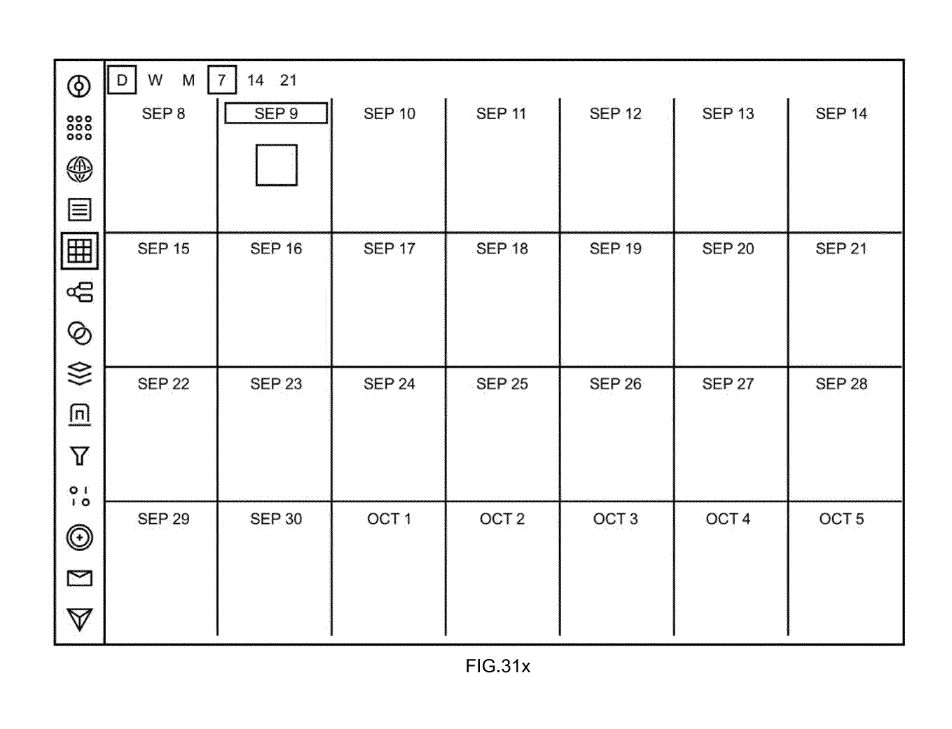

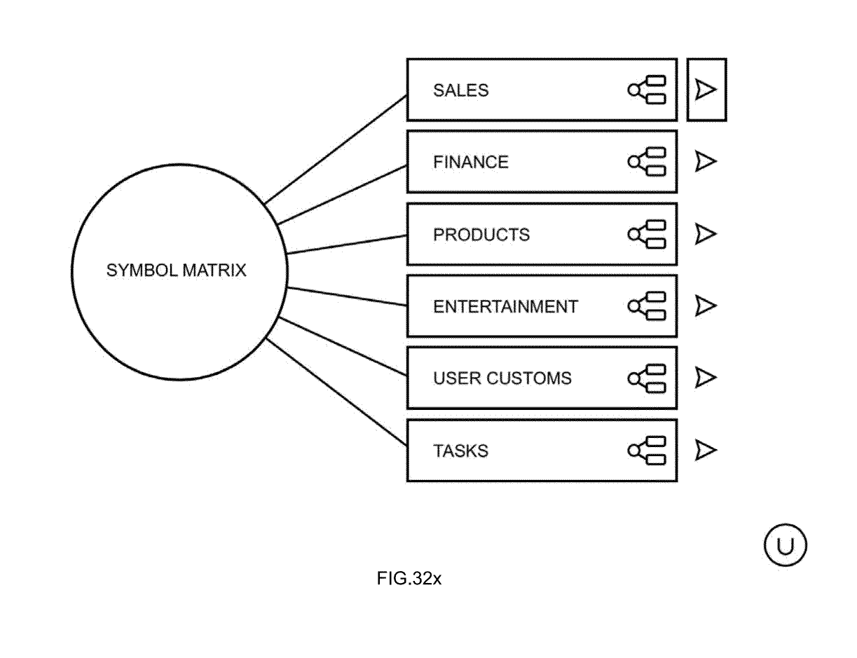

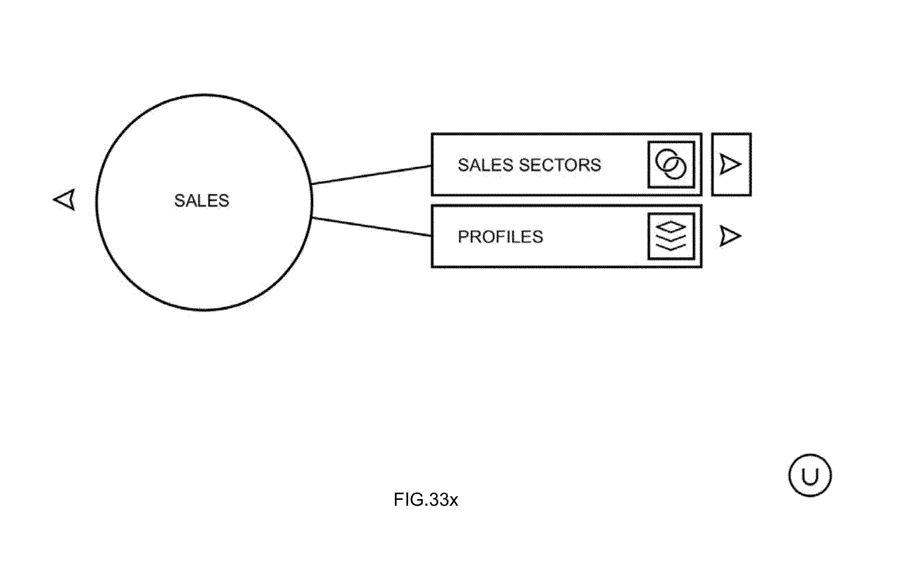

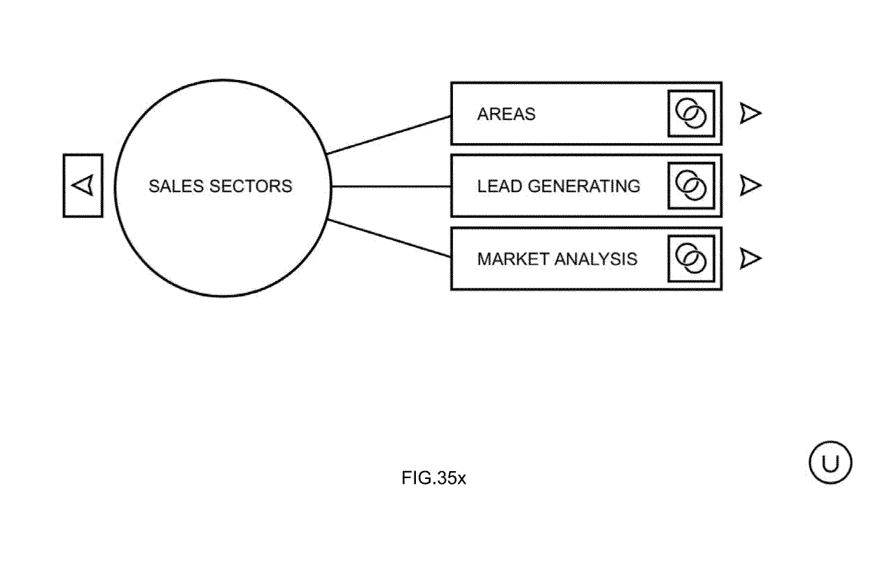

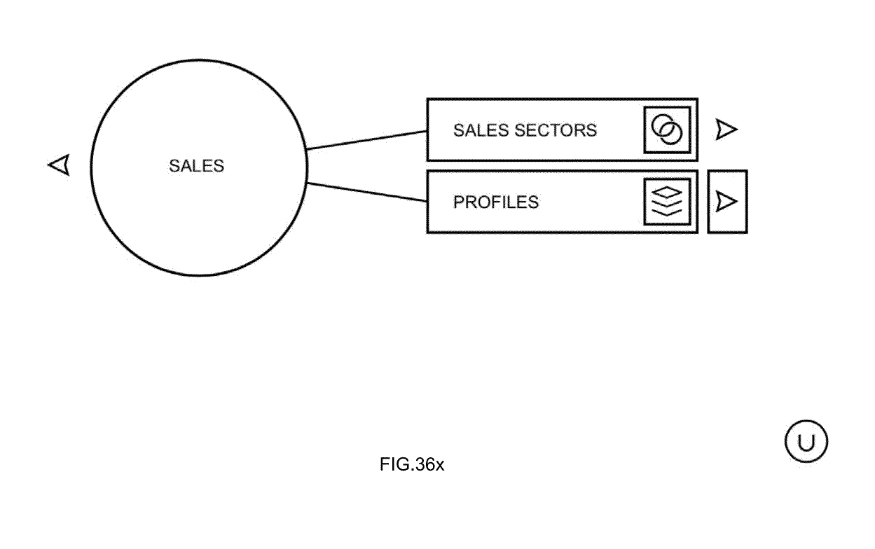

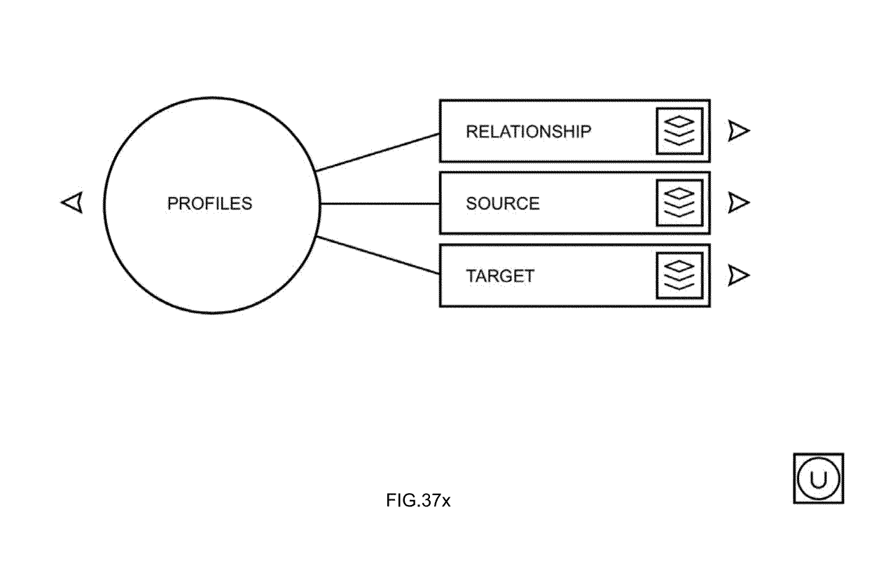

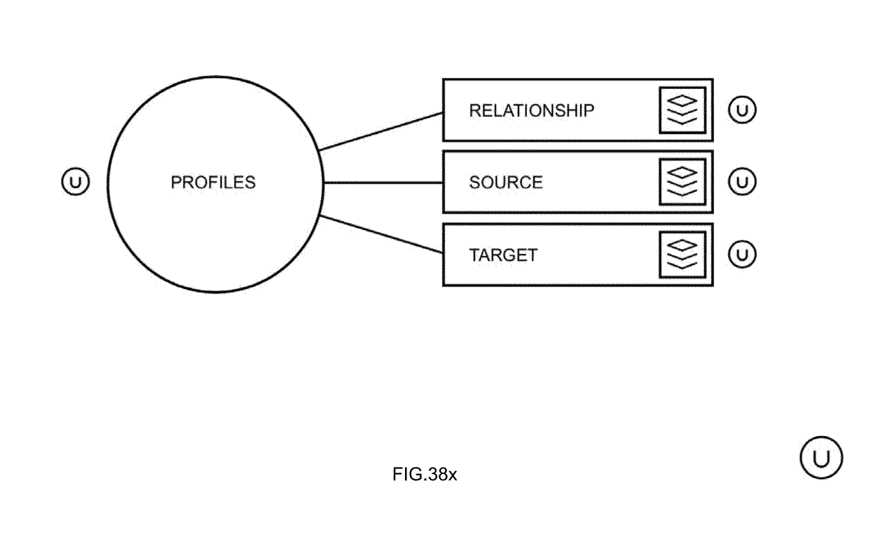

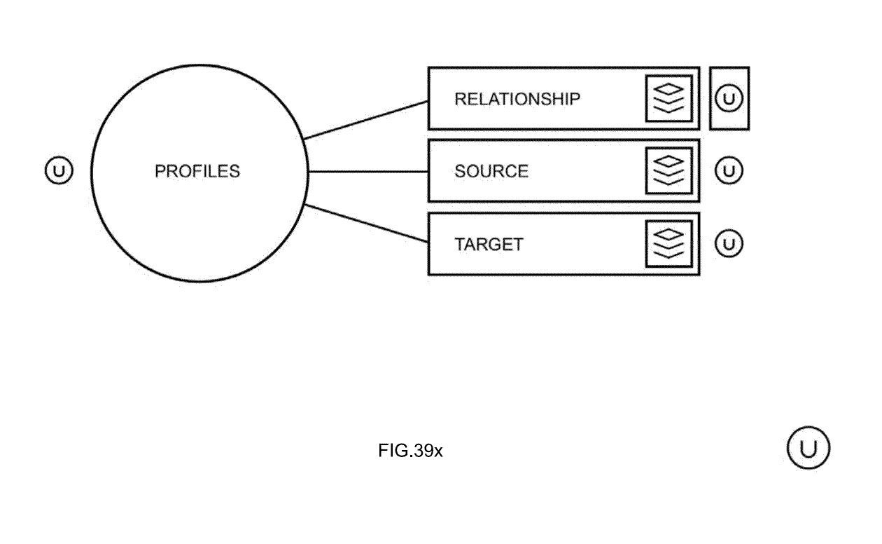

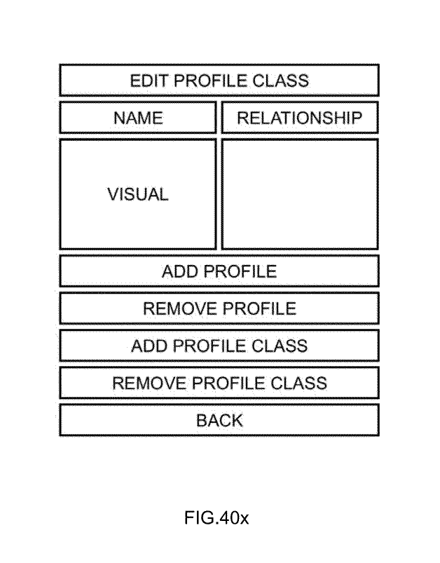

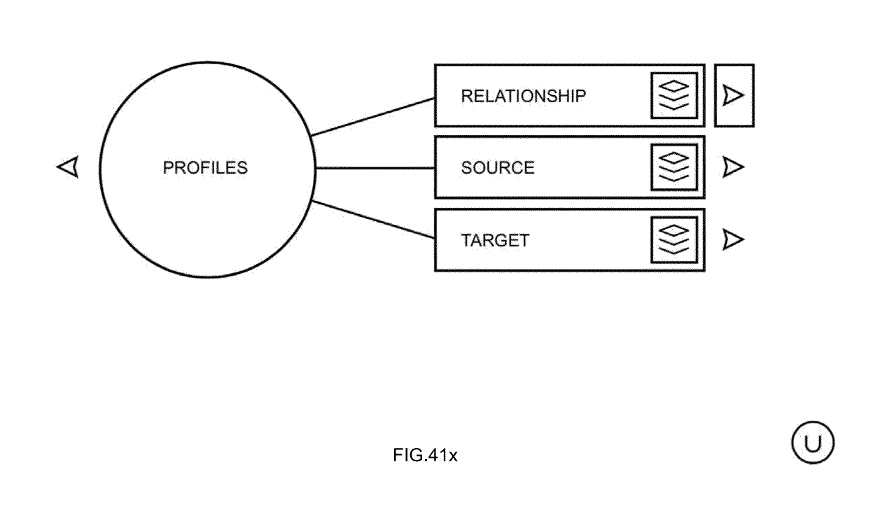

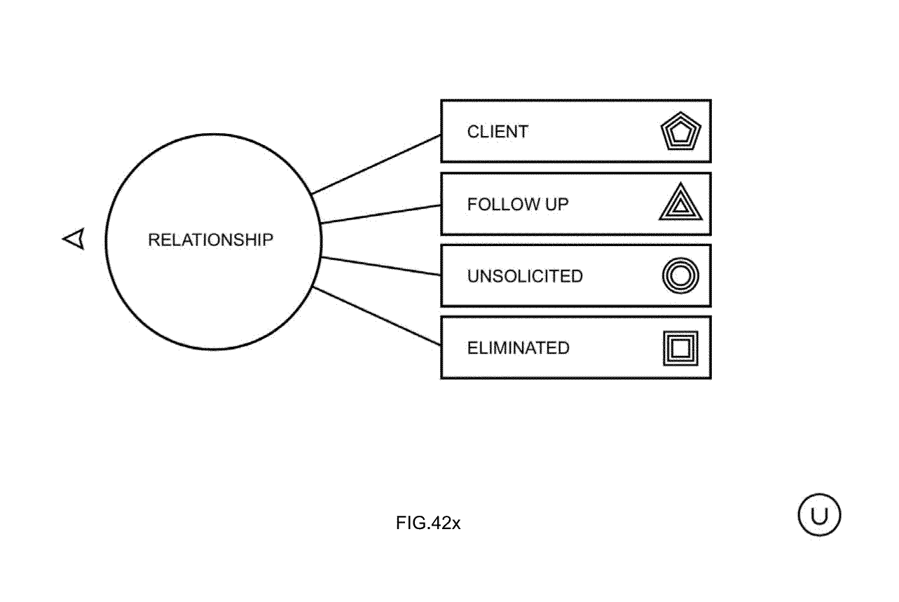

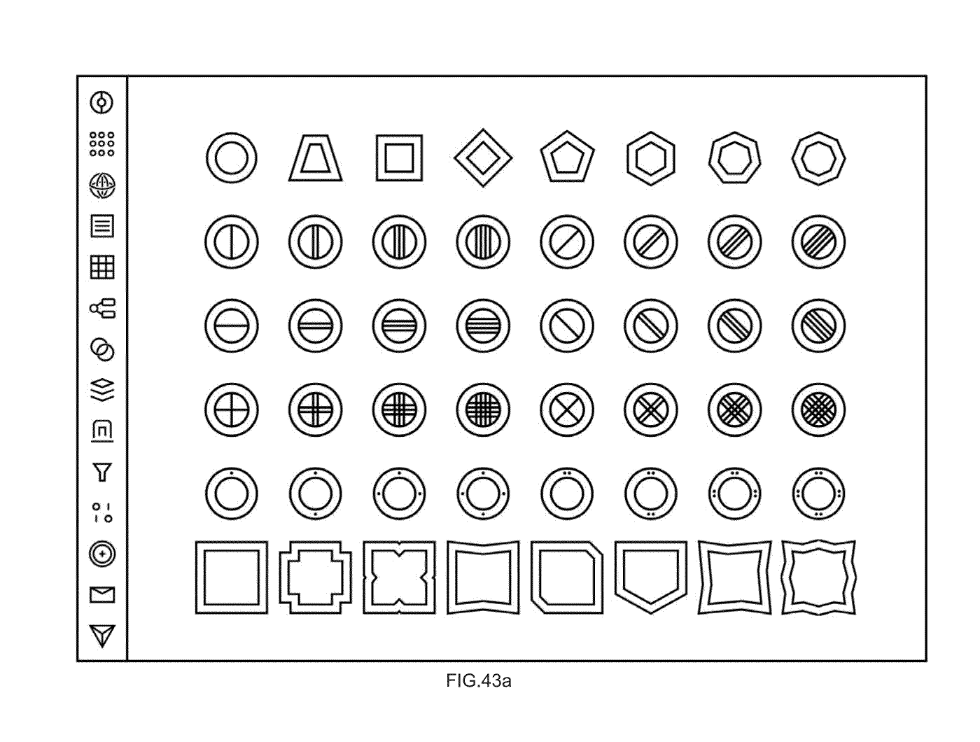

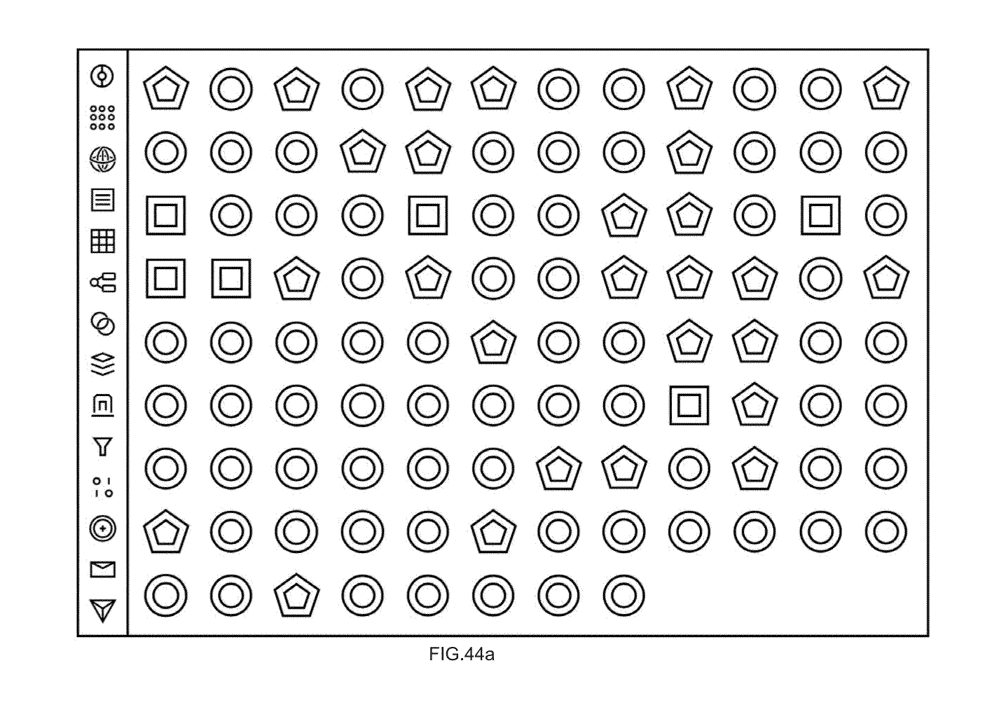

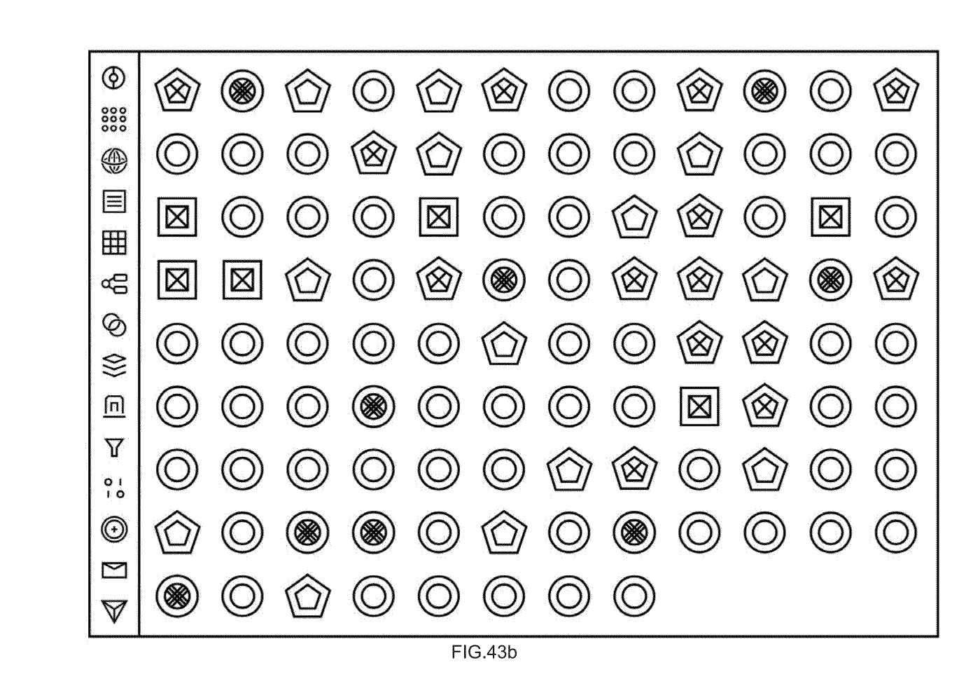

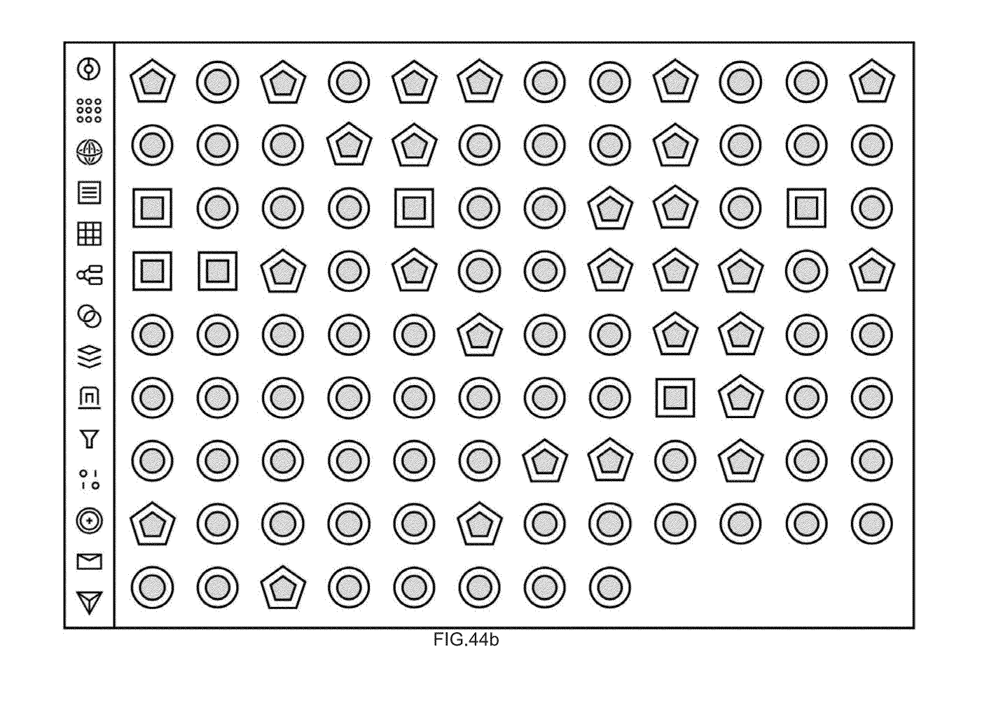

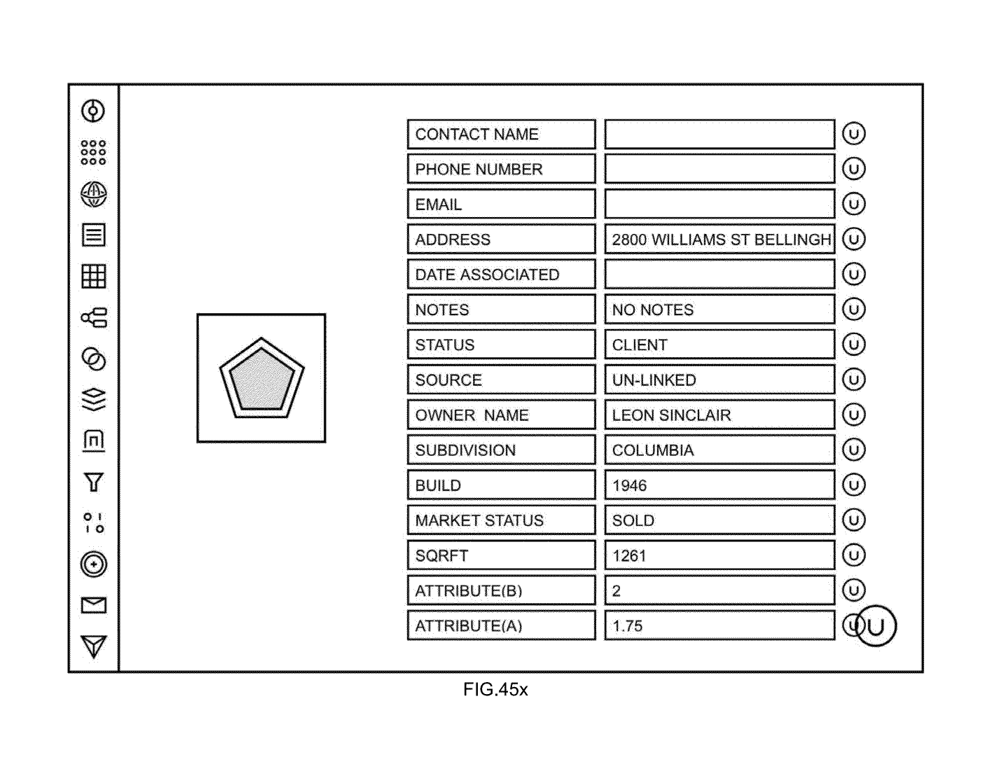

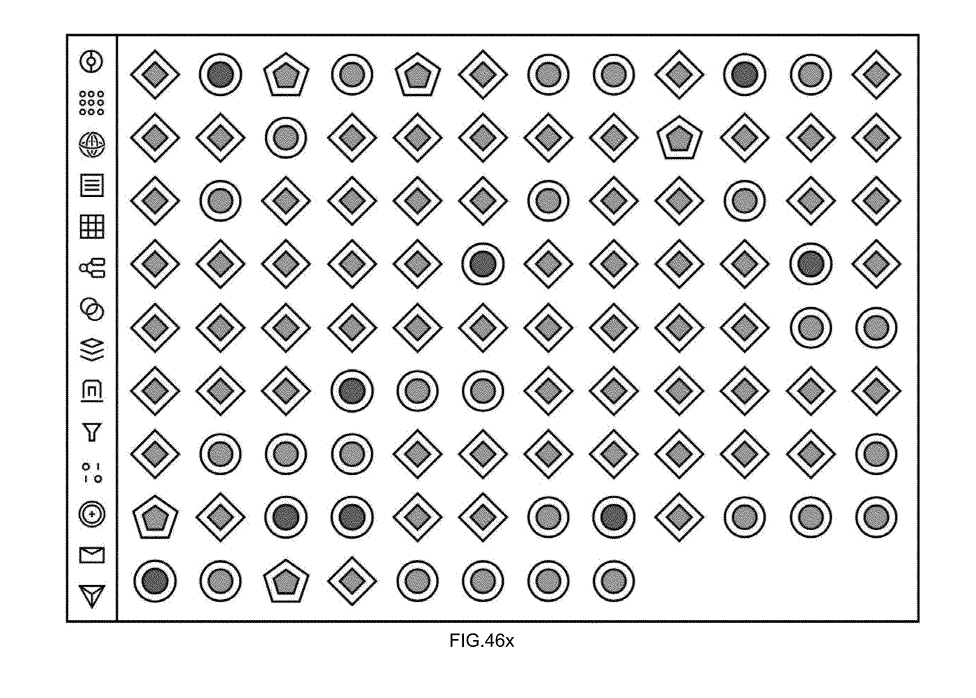

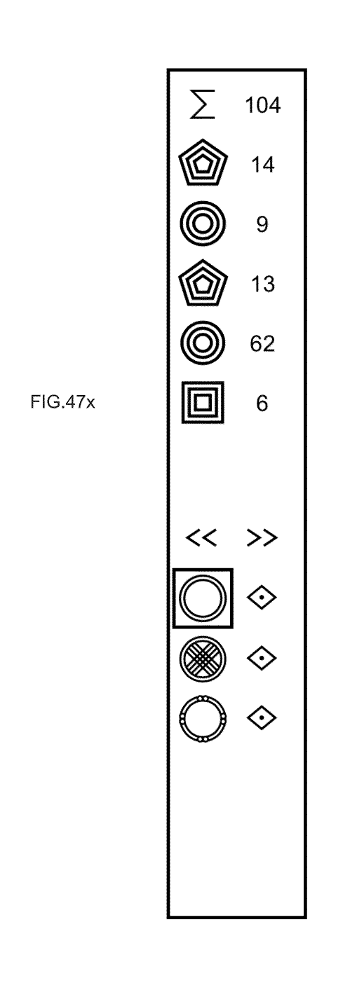

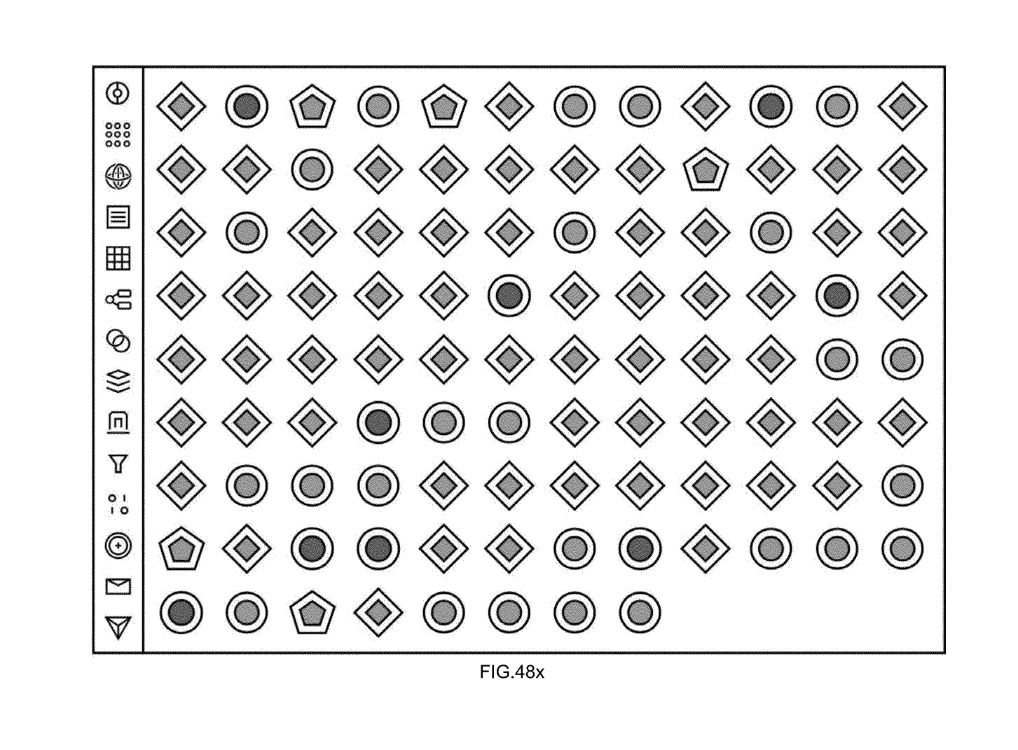

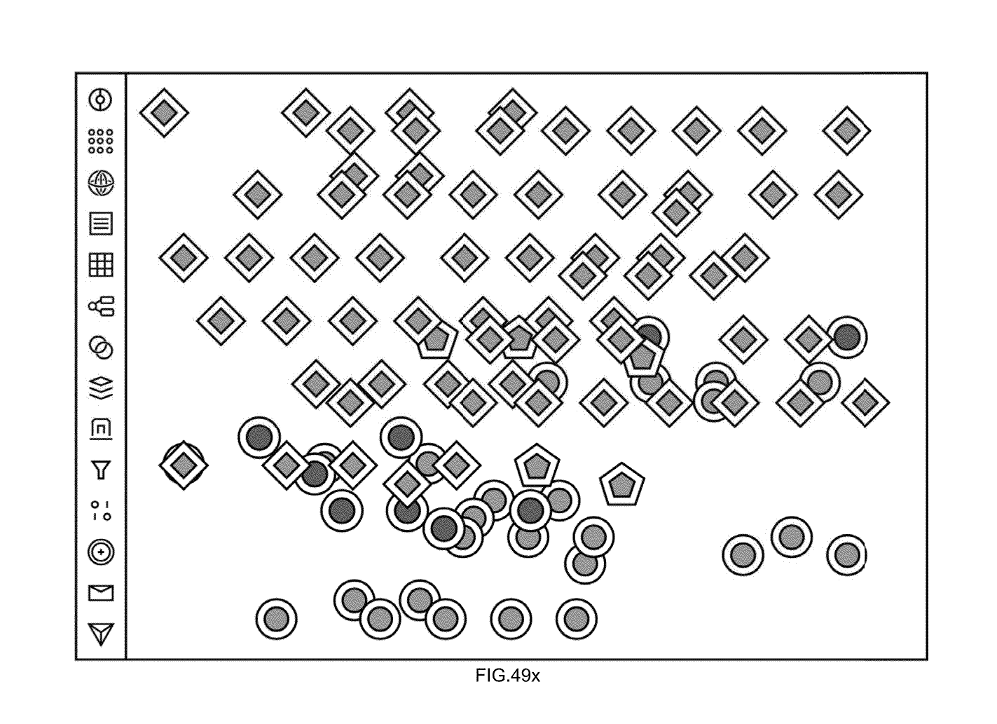

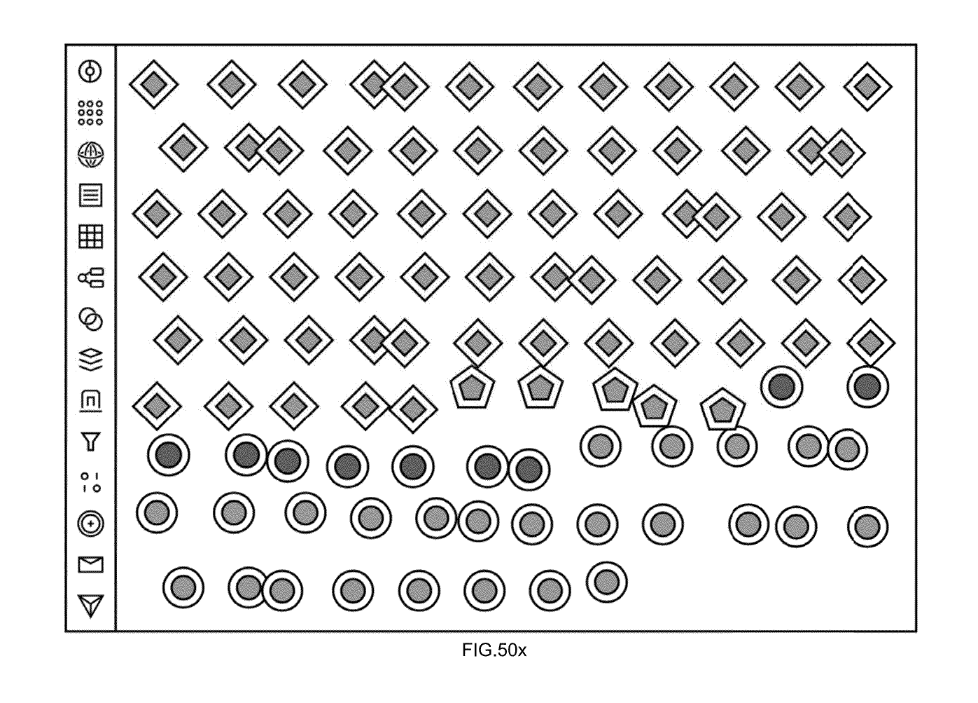

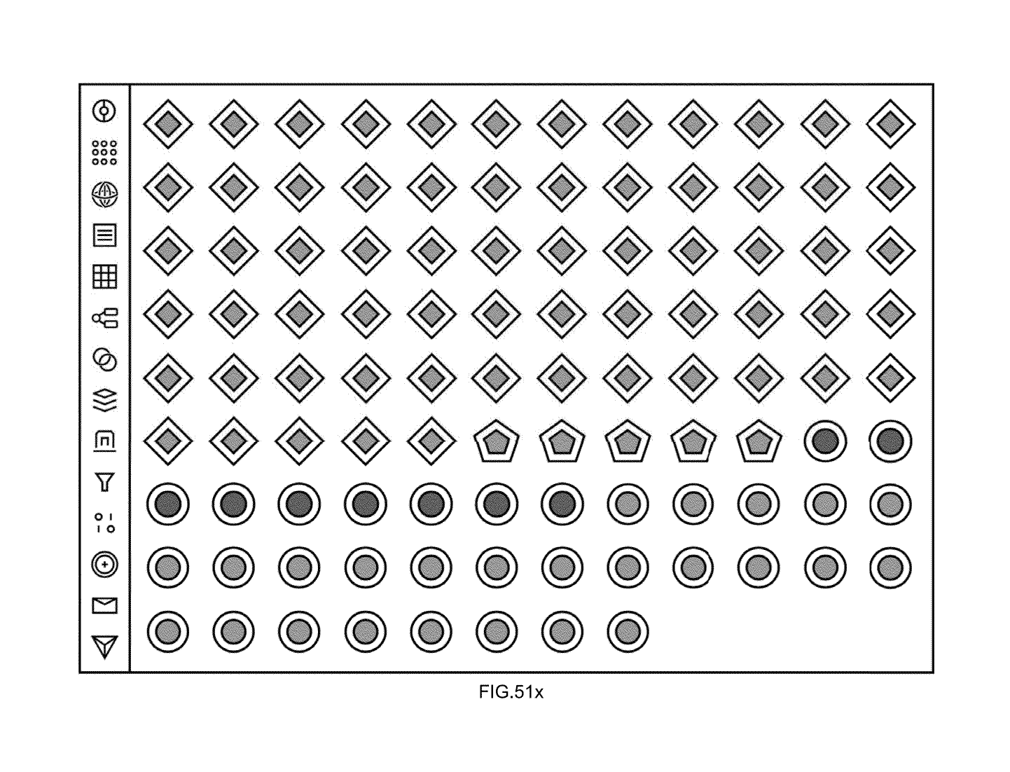

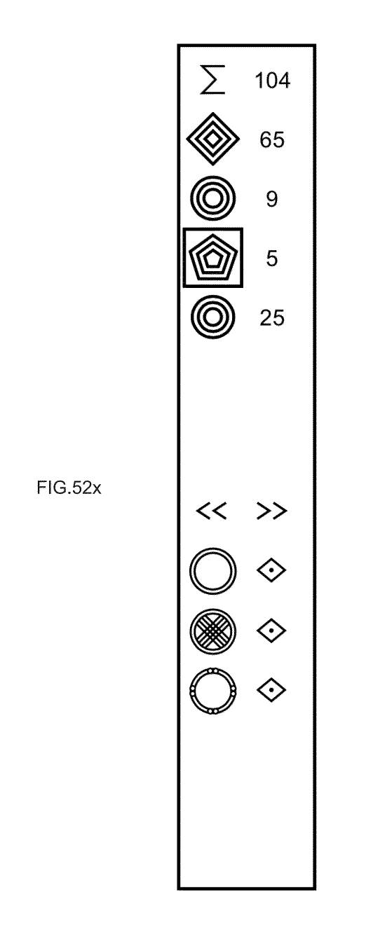

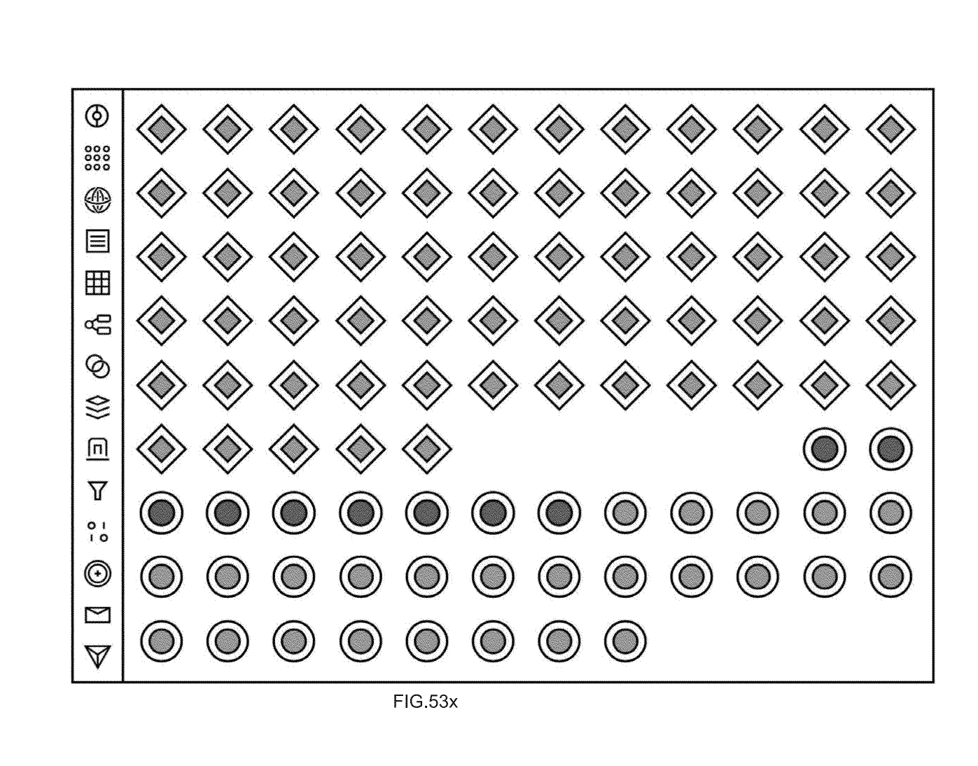

FIG. 43b—supplementary visual aid supplied related to the structural capability described in FIG. 43a, being the integration of multiple style-index structured assembled figure embellishment within the system, of differing superficial demarcation. FIG. 43a illustrates the visual attribute selection pane, while FIG. 43b illustrates example of a diversity of embellishment in the grid view of the visual format population-object viewer. FIG. 17x can be referenced which illustrates the visual attribute selection pane associated with illustrations prior to FIG. 43a. Portal entry or profile source of conditionals associated with the diversity represented by FIG. 43b fill pattern style class indexes were withheld for economy.

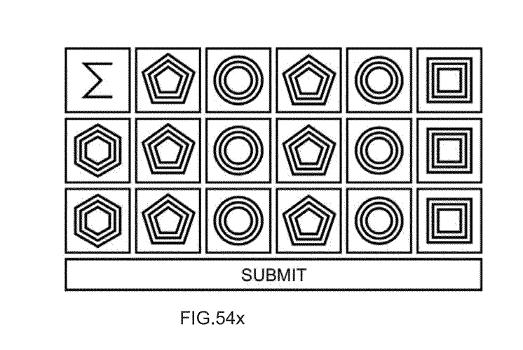

FIG. 44b—an example of color inclusion in the visual format—in this example the fill patterns which occupied the shape styles content area override the fill patters simply as a result of changes made for patent presentation—a point made to make sure that it does not confuse this represents either or as the color regions are generally partnered to underlay and act as background to figure distinctions, adding more depth to the style-index structures' ability to represent many data dimensions for a fixed cell format.

FIG. 45x—example of a prospect populations object occupying the focus position as a result of user selection. An email object may be included in the focus position visual that was included in the visuals. Use of an email object illustrates the breadth as well as the concept of a style-index structured offering that is centered around an identifying symbol in this manner where the available visual attribute styles and indexes are accommodated. Concept email objects viewed from SMX-grid with visual overlaps that overlay their status importance etc.

FIG. 46x—another example of color with diversity of object characteristic represented notice how stands out—ease of access and number of object you can have about this information at once is fantastic.

FIG. 47x—activating the control which arranges the active visual format by SMX style class category icons. Each time this is done the pre-existing ordering from the prior ordering is retained as initial reference point.

FIG. 48x-51x—example of the way in which this transition takes place—ability to transition the SMX-FOs in this way within the analysis process is another item that falls into the category of a capability now possible as a result of the visual formats discovery. This ability to design the objects with this type of user interaction marks very distinctly the value offered by the SMX-method in terms of a LDM—life data manager—choice. It is planned that the updating of visual attribute related variables of objects that occupy the focus position will ultimately all be in the format of the user actually being able to see the change in the object as if it were some sort of shape-shifter—colors transition spectrum and shapes transition from circle to square etc.

FIG. 52x—SMX-grid accommodating toggle by style-class control feature. The focus filter will be integrated with the statistic portal as a sort of switch that controls what populates the pie chart or the histogram. In addition to its access point on the map—which shines in use. Ability to view cross trends functionality of focus filter structure as a pre-regonition an originating break through point of the core concept exploited by symbol matrix functionalities—not just an isolated number or data category by seeing figuratively the change of one variable with respect to another. Also on FIG. 52x the eye control next to the grid ordering control can be used to toggle the visibility of any active style class—conveniently toggle add or subtract from what is represented on the visual format. Last transition feature—to method is on the focus filter with the SMX grid view is the empty space created by toggleing the members the remaining SMX-FOs reassemble to fill this econmize this space.

FIG. 53x—relates to FIG. 51x and FIG. 52x. FIG. 53x embodies the end state change from the initial state FIG. 51x which takes place as a result of the selection of one of three population object viewer control features: (1) show-hide visibility of all active population members which posses the associated style class index; (2) grid ordering control as demonstrated in FIG. 46x-FIG. 51 x; (3) show hide the diversity of a style class in the active population. In this case the show-hide visibility of a all active population members which posses an associated style class index is illustrated. The style class is shapes and the index is pentagon as shown in FIG. 52x. The number referenced located to the right of the active members of the active style class supplies a statistical reference total number of population objects for each of the style index active in the population viewer. Near the middle of the control feature illustrated in FIG. 52x is the left-right selections which capacitate the ability to toggle the active style classes for statistical reference and or show-hide functionality of selected style class index possessed members. The control always reflects the style class indexes which are active in the visual format population viewer.

FIG. 54x—decpicts the focus filter without showing the y-axis style.

### DETAILED DESCRIPTION

Definitions

Symbol Matrix—the name that the concept proposed and its integrated features has been assigned.

Figure Object—unique marking made up of straight or curved lines that is a vessel of information—an abstracted meaning put into form for communication or later reference.

SMX—commonly used abbreviation for symbol matrix.

SMX Structured Figure Object (SMX-FO)—a Figurative object that has been so assembled as to enable use of the unique capabilities derived from its structure which are rooted in the structured style index figure object method of assembling an option pane of visual attributes that can be associated with an SQL query that is based on the active population's entity attributes to create the core capacity offered by the symbol matrix visual format.

Structured Style-index Method of Assembling Visual Attributes of SQL Query Association and SMX-FO Representation on the Active Population—conditions which must be met for a collection of visual attributes to be qualified as possessing the functionality offered by the structured style-index method of assembling visual attribute components of the symbol matrix whose capability resulting from combination with SQL functionality is the ability to support user interaction with life data objects in this way.

Structured Style-index Method Conditions figure object visual attributes are supplied explicitly and in coordination with the following condition—in the order of visual attribute style category:

[category_member(index_{—}1),category_member(index_{—}2),( . . . )] (2) within the visual format the representation of any or all members within a given style class does not violate the unique representative trait of any other style-index visual attributes represented in the same figure object. It is the assembling of the visual format by this style-index structure in concert with the SMX other components that is the engine of the symbol matrix—the essential element—or the core method of assembling materials to achieve an outcome. Minus this one component from any feature or functionality that is implied by its conception and null value of their relation will be obvious. It is the root of the symbol matrix—the other details and descriptions that will be included are implied in offering visual format—the reason this is methoded is because to show in detail every single feature or attribute related to the structure and making use of benefits from concept would be immensely long since everything related to the new frontier of the visual format is simply by its use within the context “new.” Additionally the breadth of utility is so broad in scope is so large that general context is best suited for illustration and is also a challenge to which I believe the symbol matrix method of assembling LDOs for user interaction is a mantel inherit by its functionality. With that disclosure this document will supply the main features and functionalities as they have come further into form.

LDO—life data object.

Active Population—object population which is the focus of the SMX meaning its objects and their representation as SMX-FOs within the visual format is at present occupying the canvas of the symbol matrix's features and functionalities.

Population Entity Attribute Categories—an example best supplies (population=“men”|attribute(a)=“height”|attribute(b)=“weight”| . . . ) which is the structure by which object properties are quantified in relational databases and accessed via SQL functionality and upon which the symbol matrix method blazes forward on.

The Data Compression Effect—it is the core ability offered by the symbol matrix method of assembling LDOs which was the discovery that assembling these components in this manner made this possible. It is the capability possessed by the SMX method which was originally observed as having the capacity to transform as much as 40 pages of text table style worksheet data into 1 screen space where every entity is represented and can be seen at once.

Core Functionality—(relational data base)+(SQL functionality)+(structured style-index method of assembling the selection and progressive of visual attributes within a data visualization context or any context that is now included).

Additional features, functionalities, and descriptions will now be shown.

(Relational Database Structure)
“entity-attribute” logical and organizational structure of storing database data (SQL functionality)
dynamic RBD access and control capacity (visual format)
style-index structured method of assembling visual attribute selection with database population entity representative FIGure object to bear the next step of efficiency offered in use via the data compression effect.

Illustrations of the development of this new product are what follows, many of them detail other attributes or features which relate to the user's control of visual format—but the core distinct idea is above A.

The product embodying the present invention validates this assertion and additionally it will also verify its novelty.

Additional disclosure repeat disclosure the breadth of integrated use of the new paradigm created by the method's core makes it very difficult to even pick a place to start when mixing it with prior art methods that now being mixed with the functionalities of the visual format seem to be necessary to mention the point made above in relation to this tells the whole of this disclosure. It will focus on what is considered to be main points without attempting to show every object that could be represented in the active population . . . Which would be a matter of thinking of classes of objects.

(1) Introduction

The purpose of this document:

To supply visuals and descriptions necessary for preparation of full patent application. Visuals which show the “flow of control” (features and functionalities) of the symbol matrix with an emphasis on its application within a direct sales context.

(2) Prior Art

Methods from which the article was an improvement upon.

Concept—prequalifying data (prospecting data)

Visual (2.1)—prequalifying data (in the access format of data table)

Visual (2.2)—road map

Visual (2.3)—relationship progression data

(3) Introduct of the Symbol Matrix Method

Text description of what it does and how it does it.

Assembling data for access within the context of optimizing resource allocation decisions as well as organizational (informational access) efficiency. Value added of the symbol matrix method and the source of utility.

(4) Inventor background (origin of the invention)

(5) Illustrating the context of utility within origin context—“the sales discovery process”

Concept (a)—in order to fully illustrate the value of the invention to one whom is not familiar with direct “door to door” sales

Concept (b)—the root of sales—why it is a valued professional occupation—from what feature of “the nature of things” it is a child of.

Visual (5.1)—Imperfect Information

Concept (c)—intrinsic demand—or undiscovered demand (existing unrealized gains from trade.

Visual (5.2)—demand intensity—demand unrealized because of the impediment of “imperfect information”

Concept (d)—the law of averages and prequalifying data

Concept (e)—prospect population & the two kinds of prequalifying data (offer diversity) & (demand-demographic diversity)

Concept (f)—examples of prospect population constraints

Concept (g)—examples of offer diversity constraints

Concept (h)—examples of demand-demographic diversity (signals)

Concept (i)—applying to direct “door to door” sales profession (unique attributes of direct sales)

Concept (j)—professional direct sales

Concept (k)—categories of data management—of direct sales
(a) prequalifying—offer quality (competitiveness)
(b) prequalifying—demand intensity (demographic or other information which can be correlated to likelyhood of purchase or undiscovered demand intensity via law of averages)
(c) relationship progression—especially demanding in context of a high intensity of contacts & follow ups unique to direct sales as a result of its path to a transaction
(d) 3rd specialized professional need “presentation ques” unique data traits a prospect might possess which offer a advantage in playing off of within a presentation

(6) illustration of symbol matrix method applied to described context

Concept (a)—description of mock data set
(a) offer quality “traits”
(b) demand quality “traits”
(c) relationship progression
(d) presentation ques

Visual (6.1)—data table of mock data set

Concept (b)—symbolizing—offer quality

Visual (6.2)—symbolizing offer quality

Concept (c)—symbolizing demand quality

Visual (6.3)—symbolizing demand quality

Concept (d)—symbolizing relationship progression

Visual (6.4)—symbolizing relationship progression

Concept (e)—symbolizing presentation ques

Visual (6.5)—symbolizing presentation ques

Visual (f)—brining it all together

Visual (6.6)—8 part visual
(1) prequalifying data table—include a full example 10 pages
(2) road map
(3) road map with parcel markings
(4) sales map with default prospect object symbols
(5) sales map with relationship progression symbolized
(6) sales map with offer quality symbolized
(7) sales map with demand quality symbolized
(8) sales map with presentation ques symbolized

Sales Navigator—from beginer to professional “door to door salesman”

Concept (g) reverse engineering the logic [econometrics prediction—measuring correlation—the change in one variable with respect to another] how the focus filter makes this pratical and easy
econometrics
cross-trends

Cross-trends vs 1-dimensional conventional dashboards with respect to identifying optimal resource allocation “opportunity” within ones decision management process
(a) offer quality competitiveness—using the focus filter as a technical indicator to determine in sync with fundamental (experience) knowledge and develop ones strategy
(a.1) breaking concept—diversity of sales style and (identifying strengths/resource allocation opportunities)
(b) identifying (harder to spot) opportunities in demand intensity quality—using focus filter to cross-trend

Concept (h) (relocation|contact frequency|contact quality) trade off consideration on the fly persistent resource allocation consideration of professional direct sales person this is the origin of sales navigator discovery of the dramatic enhancement of organizational and performance efficiency possible through organizing informational access and use in this way.

(7) Origin of the Symbol Matrix

Concept (a) Initially concept was considered to be a specialty application for better supporting the process of direct “door to door” sales.

There was one blaring feature that was recognized upon first assembly which was this (transformation): the transformation of as much as 20 pages of text table style formatted information (not including the relationship progression feature) economized into an access format of such ease that no effort essentially is required in acquiring “where to go—what to do.” This is in comparison to manually compiling this information—example if I circle every address where I have a follow up and x-all my eliminated's then I might be flipping back pages back and forth to compare which follow up was the most likely or most worth attention—or a new area might be considered like this I've been issued prequalifying data for an area of 400 prospects I'm going to manually scan through it highlight which are my 1st and 2nd tier prospects and then look for a street that has a lot of quality prospects—I'd then check a road map in order to get directions to that street and once on that street I'd go down on one side of the street and then come back on the other. Relationship progression would then be written down on prospecting sheets or entered into a table electronically. This is the prior status of working the trade professionally prior to my inventing sales navigator.

Main Point—Because of the unique logistics of the job—their persistent daily inconvenience in literally burning a hole in the pocket since pay was essentially 100% performance based—the value of this method was instantly a joy—since its use is a no brainer in supporting this trade. Its absence was also recognized and verified prior to further investment of resources in its development.

Concept (b)—Two Inputs (1) Trying to look for a way to customize application for realtors (2) Zoom-scale effect—its convenience was recognized as a result of noticing the inconvenience caused by data points being lost in the process of zooming in and out on an area—the ability to snap to grid in the analysis process created a cleaned up way of seeing all data that was present on the map.

This discovery was also a joy because it liberated exploitation of the data compression effect from the constraints of a map based context. This is the death of the text table it is no longer the most efficient form of compiling blocks of information for analysis and access. And like that the invention went from direct sales specialty tool to a target market the size of the world essentially. Its like finally discovering a gold mine after years of searching then upon starting to dig discovering its actually the entrance to 1000 gold mines, once again joy. Mozart quality joy.

Visual (7.1) Snapping to Grid View

(8) Base Bones—walk through of features and functionalities

(8.1) Stem Tree Data Navigation Structure
populations
population classes
sectors
sector classes
profiles
profile classes

(8.2) Style-index Concept of the Symbol Matrix Multi-Dimensional Data Visualization Functionality Within the Constraints Of A 2-Dimensional Plaine

Data-Dimensionality

This section is a detail verbose description of origin in direct sales (prior art and source of utility within that context)

(x.1) Example

Prospecting Data Sheet (500 prospects)

Show every single page required to contain that information in a text table

(x.2) Location

(x.3) User—Contact Relationship Data—a mixed bag of electronic crm and by hand techniques for keeping track of contact status

(x.4) Example Of Electronically Updating A Contacts Relationship Status

No stem tree relationship progression demarked just selection from a list of possible relationship status.

(x.5) Example of a Data Table Which Has Contact Status Paired With Prequalifying Data (a access format that prior art makes possible to access as a report)

Serviceable context of a report—its broadness

Text table based information—not novel (its a text table via a SQL query portal and the ability to offer definition of what information to return from the data base) generally supplied in CSV format which creates the additional logistical stem of manually formatting the information via a spread sheet before its ready for use in (procedural and performance data analysis of proactive sales)

Demonstration of CSV

All formatting manual and dependent on user computer literacy which if not lacking results in a users inability to benefit from having the data in CSV format)

Possibility tree of prior art

Has prequalifying data—does not use prequalifying data

In the first case how is (1) who to contact (2) and how to keep track of relationships∥logistically performed

Has prequalifying data ---> case of having prequalifying data in electronic form—with and without application that supports updating relationship status

Who to contact? Where (how) to contact? The sales—customer relationship status resulting from contacting?

These are logistics of proactive direct sales∥other logistics like presentation—scripting—held constant (for the moment)

Theoretical basis of sales (a) source of demand for talented sales people—imperfect information—overcoming the value gap between product sales and transactions not realized as a result of—imperfect information—fighting the in-efficiency caused by imperfect information by getting the message of the offer into the minds of potential consumers and from that activity discovering if there is a win-win—the prospects demand was above the purchase threshold based on their unique input factors of circumstance and preference. In exchange for the value created for the business and the customers the sales person is rewarded with a commission or a percentage of the money brought to the business.

Prequalifying data—What is it? How is it used? Information that a company has about the market of people which it seeks to serve, note all these people have residences—they live somewhere and there is also often the feature of this being a constraint on the population of people whom service can logistically be offered to for no transportable goods—which makes it even more relevant—there is also the organizationally set market boundaries which are based on sales within a certain region which set the bounds logistically in terms of the sales leaders prospect population.

Location is very often the first condition upon which a potential prospect is filtered using prequalifying data of location based on territories of responsibility or serviceability constraints that mark the actual process of allocating resources toward delivering message to people whom could qualify as logistically able to be a customer sometimes in contacting discovery is required to ultimately determine this even after a positive initial discovery outcome—where a customer would like to purchase but it is not know for sure if a non-transportable can be offered at their residence.

This is the wild west of sales discovery created by imperfect information which offers the potential for gains just as outstanding as the inconveniences it creates—without imperfect information the sales profession would not exist SMX sales navigator would not exist and who knows what else would necessarily also be altered about the universe to meet all alternations or necessary trade offs to accommodate. So it is as encouraging as it is devastating depending on how its considered.

Assuming a prospect population bounds has been set: there is the additional step of sales discovery resource allocation—of all the people who have met the condition to whom is it most worth while to contact. Allocating resources toward prospect population members whom—are the most likely based on some leading signal base on fundamental laws of cause and effect are most likely statistically to result in the discovery of a win-win and processing of a transaction?

This is mainly determined by two input factors:
1. circumstance and preference of prospect
2. what you can offer a prospect

What you can offer a certain person may depend on there current status with a company.

If a member of the prospect population is already then this is likely a matter of maintain the customers satisfaction via customer service and in fact filters that member of the potential customer population out of the list of contacts with whom a transaction is a possible outcome. The other consideration is type for companies that sell multiple services which are restricted by location diversity or variance of what can be offered to any given prospect may vary—based on this factor (1) this means that the what you can offer a given prospect is filtered by current status—the result is that some offers may be better other offers may be worse—they will be different and very unlikely to be the same in terms of what they bring to the table. Making one demographic type of prospect more worth allocating sales discovery resources towards then another.

This would be the second major filter in defining a segment of people with whom to allocated sales discovery resources towards.

Now we're down to the nitty gritty—of the remaining population which is within the territory of target market or serviceability whom is the most qualified to allocated resources towards in the sales discovery process?

Here prequalifying data and its use is the key potential tool of optimizing resource allocation within the sales discovery process. The key is leading indicators or signals which effect—once this information is compiled in accessible format other logistical consideration come into play—with proactive direct sales this is In fact at a 1 on a 0-1 index because you can't be two places at once. you can only be one place:

Example: based on your prequalifying data the absolute best juciest sure to buy 1 out 3 times might be 10 blocks away or they might be scattered a driving distance across the whole town one is responsible for selling to. This creates a sort of balancing act of allocating resources—the transaction cost of transportation from one highest quality prospect to another might be so high that it offsets the benefit of only talking to highest likelyhood prospects. The greater number of 2nd and 3rd tier that can be contacted via parking and canvasing a neighborhood might result in greater commissions. This factor is a quality unique to direct proactive sales.

Telemarketing does not face this constraint—nor does mailers—or any other form of sales and marketing with respects to the cost of reconfiguring ones individual resource allocation strategy toward maximizing sales efficiency—its not an input factor—the distance walking or dringing transporting ones self with respect to optimizing resource allocation is—entirely void not a variable within the equation literally. There may be comparable situations of considering trade offs (do I purchase a really expensive billboard downtown or do I buy a bunch of smaller ones scattered on the outside of town) the person measuring the relative opportunities (at no point) has to consider the cost or the physical distance of transporting ones self from one location to another as an input factor to if this is good for business—its irrelevant what matters is which will result in the most business getting the message into the minds of the most people who will take the offer. If a decision maker for a business equates how long or the cost of them driving from one to the other that would be irrational his transportation from one to another has not impact on which opportunity will ultimately be the optimal decision.

So we have progressed in this fashion:

Prequalifying the prospect population
1. filter one territorial bounds
2. defined by area of resonsibility of a sales leader or products and services which are restricted by residence location based serviceability the ability to receive the service at ones residence restricting whether a prospect can or cannot be a customer
3. service status (business context (1) effects (2) doesn't matter to sales strategy outcome)
4. professional filters—these filters are based on information such as area knowledge transaction history—time of last transaction—age—sex—external circumstance time if the year—even the weather (selling lemonade on a street corner in the middle of winter probably not going to yield many transactions selling internet service to college students moving back to campus in fall highly likely to result in many transactions)—these detail filters are gained through experience and learning and refining prospect targeting)

(3) Service Status Factor—business possibility tree ((1) restricts whether or not another purchase can be made (2) has no bearing on allowance to purchase again but the recency of last purchase may be a statistical signal the prospect quality (3) multiple product direct sales organizations where what can be offered may fall into categories (ax) can't sell to existing customers of both products (bx) can sell existing customers of product (a) product (b) (cx) can sell existing customers of product (b) product (a) (dx) can sell non existing customers product (a), product (b) or both product (a) and product (b)).

In this case there may also be differing offers allowed to sale each product for example product (a) can be sold at rate(z) to a customer without any products or it can be sold at rate(y) to customer who already has product (b).

Each case alters a very important input factor to the outcome of initiating a sales discovery interaction—it is a consideration in terms of the kind of prospect one is dealing with which changes the discovery presentation—what questions are asked in what order—what objects are likely to arise—can enable one to customize presentation and prepare their mind for a smooth discovery—making the discovery process natural and efficient.

The effect of studying this information prior to allocation resources physically assuming the logistical transportation cost of going to contact one prospect rather than another—is in some cases the difference between cutting as a door to door salesman or not. Its the difference between earning piles of gold or not being able to pay ones bills. And the location input of logistical consideration for physical day by day transportation cost based on distance of prospects is a constant trade off consideration which requires the input of distance (cost of gas) relative prequalifying quality of prospects on one location relative to another.

With this in mind the context from which sales navigator and symbol matrix was born were these:
1. prospect population input factors of:
   a. location serviceability restriction
   b. over arching territorial bound restriction
2. service status restriction & multiple product types which determined offers
3. direct door to door sales (which has two very unique and distinct logistical considerations (a) finding assigned areas neighborhoods never before visited street name layouts not know where located it was requisite to look up the location where the location was and write down or GPS how to get to it (b) the resource allocation consideration of trade-offs of optimizing production while balancing expectation of profit from contacting a higher number of 2nd and 3^{rd} tier prospect types located closely in an area making the logistics of transporting ones self from one location to the next very low relative to the expected profit of contacting the highest likelihood prospects based on the prequalifying which were less common and normally spread out over a 8 block territory or even a whole town—making the physical transaction cost higher for only talking to highest likelyhood prospects distance between locations for walking
4. or driving the exact location of a residence as a pre-requisite for contacting saturated the occupation which I obsessively worked sometimes 7 days a week.)

Other forms of contacting billboards advertising commercials mailers—the process of knowing exactly how to get to a location is not a necessary bit of information for the worker—yes there are sometimes appointments—which generally involve meeting at a know place where one or the other person then guides to another destination—and GPS is used in sales marketing and business—but is incomparable in use and intensity of use to direct sales. Only in direct sales is it actually consider continuously throughout the process in terms of contact quality vs transportation cost. More contacts of a lesser quality more tightly located vs less contacts of a high quality that are more spread out and less common. Even this feature requires an additional stem of the direct sales person of use of prequalifying data as a means to categorizing prospect quality for which the consideration of trade-off in transportation cost vs prospect quality becomes a consideration.

Without this experience recognition of the value and discovery of the sales navigator method of supplying data access to more efficiently serve the organizational and performance efficacy of proactive sales would have been impossible—these persistent unique logistical considerations were requisite and even so the idea didn't come until (1) the cost of inferior access format was discovered (2) the monetary opportunity for supply a better service was recognized. Combining the core data organization and logistical needs (1) prequalifying data (2) location data (3) relationship progression data into a single data access format composed like this (1) lot map marking location clearly demarked with parcel boundaries (2) relationship progression—marked by shape of location marker (3) prospect demographic type marked by color or fill pattern—that is the new paradigm mixing its core with prior art does not elevate prior art—its obvious certain features and functionalities will be included—and you can't get those without knowledge of the core.

Unique feature of direct sales—100% commission based comensation working as independent contractor acquiring this knowledge of concentration on highest quality prospect by force of needing performance to get paid and in fact survive purchase food and shelter.

I was paid nothing for trying only performance.

Three access formats required to meet logistical demands of proactive direct sales—combining multiple access formats into a single integrated access format (relationship progression x prequalifying (demand intensity & offer quality factors) x location)

Planned Visuals Of How The Symbol Matrix Works—how use of the symbol matrix concept is supplied:
(1) selecting a population—concept: breadth of utility
(2) adding a visual attribute via the symbol control portal—concept: style-index concept adding information to the same figure set without losing the integrity of information present
(3) referencing active settings
(4) resetting objects to default population symbol
(5) editing a populations default
(6) creating a profile
(7) applying a profile—applying multiple symbol conditionals at once via profile functionally—paired with ability to apply (add edit or even remove) child profiles singularly
(8) editing a profile
(9) accessing an objects specific details
   a. concept generalization most relevant population features
   b. paired with ease of access in accessing specifics c) example—opportunity identification from a general access scope that represents all objects singularly+essentially instant access of specifics for those instances which require or are worthy of specific attention—or qualify via their general diversity for resource allocation toward acquiring specific information
   c. sales follow ups—tasks time efficiency—financial analysis investment opportunity identification
(10) resetting the active visual format
(11) applying different profile set to same population objects for analysis purpose or studying historic results as a means of adjusting ones strategy
   a. performance efficiency
   b. as well as organizational efficiency of profile control functionality
   c. utility derived from linear cumulative data-user relationship not limited to a single context in life a ldm “life data managment” tool
(12) changing sectors
   a. within same population active visual format is applied to new sector upon changing sectors
   b. in going from one population back to a prior the visual format that was last active is updated in accordance with any alteration within the underlaying
   c. data series as well as for data that has an intense update frequency in-time representation of those changes based on the underlying user defined
   d. conditionals which define what information is represented by the visual format
(13) creating a sector
(14) editing a sector
(15) time filtering a sector
(16) adding an a member to a population
(17) creating a population
(18) data control features (data table—details) which data categories are included in what order and in which way is that data category to be formatted
(19) data types and formats
   a. data populations types
   b. supplying making available symbol matrix visual format compatible facts and figures information access
   c. in a cumulative linear use for accessing storing and organizing knowledge and servicing data needs
(20) special types—user defined categorical (relationship opinion ranking—class) and distributions statistical deviance style category whose index values mark differing positions within a distribute sd+2 sd+1 sd−1 sd−2 ( . . . )
(21) updating user defined data—of data categories that are related to a style class (relationship status && shape) demonstration of ability to update via selection from a stem tree which supplies the update options in form of their symbol style indexes
(22) creating or appending a data category to a populations availible data category sets
(23) derivative data categories which sum, or create and index value or categorical standing such a “category type of object” <---> to me
   a. prospect type
   b. financial opportunity type
   c. task type
   d. cross trends via focus filter and enhancing focus filter cross trend ratios eash of access via partnership and dynmatic integrated linked functionality of prior art conventional methods of data visualization such as pie chart—histogram—time series—and correlation graphs
(24) stem tree data navigation underlaying structure
   a. a population by default always has two root children within the stem tree structure
   b. one is the populations root sector class
   c. two is the populations root profile class
   d. beyond these control over the assembly of sectors/profiles or additional profile/sector classes controlled created and defined by the user are malleable
(25) grid ordering
(26) show hide via style
(27) focus filter map
(28) focus filter calendar
(29) focus filter SMX
(30) SMX versatile re-economization of screen space
(31) SMX focus filter with data table
(32) focus filter with statistical formats
(33) class symbols
(34) class symbol navigation short cut
(35) demonstrating use in non-sales contexts
   a. finance
   b. tasks
   c. entertainment
   d. shopping
   e. citizenry

Examples of use in different context:
finance
instrument skill acquisition piano

What is claimed is:

1. A data visualization system comprising:
a database containing a plurality of data fields each containing a plurality of data values;
a display system; and
a processing system in communication with the database system and the display system; whereby
the processing system generates display data for at least one displayed data fields of the plurality of data fields;
the display data determines visual attributes for each displayed data field based on the data values of the data associated with each displayed data field; and
the processing system controls the display system to display the display data.
